(19) United States
(12) Patent Application Publication
(10) Pub. No.: US 2008/0182951 A1
(43) Pub. Date: Jul. 31, 2008

(54) Chromium Pyridine Bis(Oxazoline) And Related Catalysts For Ethylene Dimerization

(76) Inventors: Lily J. Ackerman, San Francisco, CA (US); Gary Michael Diamond, Menlo Park, CA (US); Keith Anthony Hall, San Jose, CA (US); James M. Longmire, San Jose, CA (US); Mark L. Micklatcher, Hayward, CA (US)

Correspondence Address: EXXONMOBIL CHEMICAL COMPANY, 5200 BAYWAY DRIVE, P.O. BOX 2149, BAYTOWN, TX, 77522-2149, US

(21) Appl. No.: 11/955,969

(22) Filed: Dec. 13, 2007

Related U.S. Application Data
(60) Provisional application No. 60/879,128, filed on Jan. 8, 2007.

(51) Int. Cl. C08F 4/78

(52) U.S. Cl. 526/154; 526/170; 502/152; 502/154

(57) ABSTRACT

The present invention provides a method of producing oligomers of olefins, comprising reacting olefins with a chromium based catalyst under oligomerization conditions. The catalyst can be the product of the combination of a chromium compound and a pyridyl bis(oxazoline) or pyridyl bis(thiazoline) ligand. In particular embodiments, the catalyst composition can be used to dimerize ethylene to butenes.

### PRIORITY CLAIM

This application claims priority to and the benefit of U Ser. No. 60/879,128, filed Jan. 8, 2007.

### STATEMENT OF RELATED CASES

This application is related to concurrently filed patent applications U.S. Ser. No. 60/879,131, filed Jan. 8, 2007, U.S. Ser. No. 60/879,127, filed Jan. 8, 2007, U.S. Ser. No. 60/879,129, filed Jan. 8, 2007, and U.S. Ser. No. 60/879,130, filed Jan. 8, 2007.

### FIELD OF THE INVENTION

This invention relates to the selective oligomerization (specifically dimerization) of olefins (specifically ethylene) using chromium based catalysts.

### BACKGROUND OF THE INVENTION

The oligomerization of ethylene typically returns a broad distribution of 1-olefins having an even number of carbon atoms (C₄, C₆, C₈, C₁₀, etc.). These products range in commercial value, of which 1-butene may be the most useful, as it is a comonomer commonly used in the production of commercial ethylene-based copolymers.

A recent overview of the dimerization of ethylene to butene is presented in review “Dimerization and Codimerization” by Olivier-Bourbigou et al. in Applied Homogeneous Catalysis with Organometallic Compounds (2nd Edition), Vol 1, pp 253-265, (Ed. Cornils, B., & Herrmann, W. A., Wiley-VCH Verlag GmbH, Weinheim, Germany, 2002), This article reviews mainly the dimerization and co-dimerization of ethylene, propylene, and n-butenes catalyzed by cationic nickel complexes, while the syntheses of 1-butene and 1-hexene from ethylene using titanium or chromium complex catalysts are also discussed.

The recent paper by Small et al., Macromolecules 2004, 37, pp 4375-4386, titled “New Chromium Complexes for Ethylene Oligomerization: Extended Use of Tridentate Ligands in Metal-Catalyzed Olefin Polymerization”, describes the synthesis of chromium pyridine bis(imine) complexes and the use of such complexes as catalysts for ethylene polymerization and oligomerization, including in some cases the dimerization of ethylene to 1-butene, and in one case the dimerization of ethylene to 2-butene. Small et al. reported “small to moderate amounts of polyethylene byproducts” for all the reactions. Small describes the effect of substitution of the ligands on the products produced (dimers, oligomers and/or polymers). Small does not describe chromium pyridine bis(oxazoline) complexes or use of such complexes as catalysts for ethylene dimerization. See also the PCT patent application WO 2003/054038 A2 by Small et al. for Chevron Phillips Chemical Company titled “Metal-tridentate ligand complex-containing catalyst system for olefin polymerization and dimerization and polyolefins prepared thereby.”

A 1972 paper “Polymerizations with homogeneous chromium catalysts” Zuech, E. A., J. of Polym. Sci., Polym. Chem. Ed. (1972), 10(12), pp 3665-3672, and two US patents (U.S. Pat. No. 3,726,939 (1973) and U.S. Pat. No. 3,627,700 (1971), both titled “Dimerization of olefins with chromium halide complex catalysts systems”), by Zeuch (Phillips Petroleum Co.) describe the dimerization and/or polymerization of ethylene using catalysts comprising chromium complexes (including Cr halides CrCl₂L₂, CrCl₂L₂(NO)₂, CrCl₃L₃, and [CrCl₃L₂]₂ (where the ligand L=pyridine, Bu₃P, Bu₃PO, Ph₃PO, 4-ethylpyridine, etc.), and organoaluminum halide cocatalysts (e.g. EtAlCl₂). In particular, the dimerization of ethylene and/or propylene was performed in the presence of catalysts comprising the Cr complexes: (pyridine)₃CrCl₃, [(Bu₃P)₂CrCl₃]₂, (4-ethylpyridine)₃CrCl₃, (4-ethylpyridine)₂(NO)₂CrCl₂, and (Ph₃PO)₂(NO)₂CrCl₂.

The reviews by Gibson & Spitzmesser, Chem. Rev., 103 (1), pp 283-316, (2003), titled “Advances in Non-Metallocene Olefin Polymerization Catalysis”, and by Britovsek et al., Angewandte Chem. Int. Ed., 38(4), pp 428-447, (1999), titled “The Search for New-Generation Olefin Polymerization Catalysts: Life beyond Metallocenes”, both describe a range of non-metallocene chromium complexes incorporating N-bound ligands that catalyze the polymerization or oligomerization of olefins, including the selective trimerization of ethylene. Neither review describes chromium pyridine bis(oxazoline) complexes or the use of such complexes as catalysts for ethylene dimerization.

Several references (WO 2000/69923 A1 (Devore et al) for Dow Chemical Company (2000); Esteruelas, et al., New Journal of Chemistry (2002), 26(11), pp 1542-1544; European Patent Application EP 1325924 A1 (Mendez Llatas, et al.) for Repsol (2003); US Patent Application 20040087434 A1 (Llatas, et al.) for Repsol (2004)) disclose the synthesis of chromium pyridine bis(oxazoline) complexes and/or use of such complexes as catalysts for ethylene polymerization to solid polyethylene products, but do not disclose selective oligomerization of ethylene or dimerization of ethylene to butene.

In particular, WO 200069923 A1 (Devore et al, 2000) discloses synthesis of the chromium pyridine bis(oxazoline) complex [2,6-bis[(4S)-isopropyl-2-oxazolin-2-yl]pyridine]CrCl₂, but does not exemplify its use as catalyst.

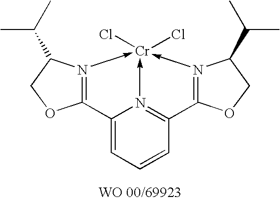

Esteruelas, et al., New Journal of Chemistry (2002), 26(11), pp 1542-1544, discloses the complex [2,6-bis[(4S)-isopropyl-2-oxazolin-2-yl]pyridine]CrCl3, prepared by reaction of CrCl3(THF)3 with 2,6-bis[(4S)-isopropyl-2-oxazolin-2-yl]pyridine, which catalyzes ethylene homopolymerization and ethylene/1-hexene copolymerization in the presence of methylaluminoxane. The polymer products are white fibrous solids.

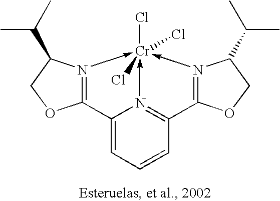

The complex shown above is included as “Complex 1” in two patent applications from Esteruelas and coworkers (European Patent Application EP 1325924 A1 (Mendez Llatas, et al.) for Repsol (2003); US Patent Application 20040087434 A1 (Llatas, et al.) for Repsol (2004)). No polymerization examples are given for this complex in these applications. Most of the examples in these applications relate to chromium pyridine bis(imine) complexes, similar to those described by Small et al. (as described above).

Several catalysts useful for the oligomerization of olefin monomers have also been developed, including the trimerization of ethylene. Several of these catalysts use chromium as a metal center. For example, U.S. Pat. No. 4,668,838, assigned to Union Carbide Chemicals and Plastics Technology Corporation, discloses a chromium catalyst complex formed by contacting a chromium compound with hydrolyzed hydrocarbyl aluminum and a donor ligand such as hydrocarbyl isonitriles, amines, and ethers. U.S. Pat. No. 5,137,994 discloses a chromium catalyst formed by the reaction products of bis-triarylsilyl chromates and trihydrocarbylaluminum compounds.

U.S. Pat. No. 5,198,563 and related patents, issued to Phillips Petroleum Company, disclose chromium-containing catalysts containing monodentate amine/amide ligands. A chromium catalyst complex formed by contacting an aluminum alkyl or a halogenated aluminum alkyl and a pyrrole-containing compound prior to contacting with a chromium containing compound is disclosed in U.S. Pat. Nos. 5,382,738, 5,438,027, 5,523,507, 5,543,375, and 5,856,257. Similar catalyst complexes are also disclosed in EP0416304B1, EP0608447B1, EP0780353B1, and CA2087578.

Several patents assigned to Mitsubishi Chemicals also disclose chromium catalyst complexes formed from a chromium compound, a pyrrole ring-containing compound, an aluminum alkyl, and a halide containing compound, including U.S. Pat. Nos. 5,491,272, 5,750,817, and 6,133,495. Other catalyst complexes are formed by contacting a chromium compound with a nitrogen containing compound such as a primary or secondary amine, amide, or imide, and an aluminum alkyl, as disclosed in U.S. Pat. Nos. 5,750,816, 5,856,612, and 5,910,619.

EP0537609 discloses a chromium complex containing a coordinating polydentate ligand and an alumoxane. Similarly, CA2115639 discloses a polydentate phosphine ligand.

EP0614865B1, issued to Sumitomo Chemical Co., Ltd., discloses a catalyst prepared by dissolving a chromium compound, a heterocyclic compound having a pyrrole ring or an imidazole ring, and an aluminum compound. EP0699648B1 discloses a catalyst obtained by contacting chromium containing compound with a di- or tri-alkyl aluminum hydride, a pyrrole compound or a derivative thereof, and a group 13 (III B) halogen compound.

WO03/053890, and McGuinness et al., J. Am. Chem. Soc. 125, 5272-5273, (2003), disclose a chromium complex of tridentate phosphine ligands and methylalumoxane (MAO) cocatalyst. However, due to serious drawbacks in the preparation of the phosphine-containing system, the use of a thioether donor group to replace the phosphorus donor in the ligands was also investigated.

WO02/083306A2 discloses a catalyst formed from a chromium source, a substituted phenol, and an organoaluminum compound. WO03/004158A2 discloses a catalyst system which includes a chromium source and a ligand comprising a substituted five membered carbocyclic ring or similar derivatives.

U.S. Pat. No. 5,968,866 discloses a catalyst comprising a chromium complex which contains a coordinating asymmetric tridentate phosphine and an alumoxane. Carter et al., Chem. Commun., 2002, pp. 858-859 disclosed an ethylene trimerization catalyst obtained by contacting a chromium source, ligands bearing ortho-methoxy-substituted aryl groups, and an alkyl alumoxane activator. Similarly, WO02/04119A1 discloses a catalyst comprising a source of chromium, molybdenum, or tungsten, and a ligand containing at least one phosphorus, arsenic, or antimony atom bound to at least one (hetero)hydrocarbyl group.

Japanese patent application JP 2001187345A2 (Tosoh Corp., Japan) discloses ethylene trimerization catalysts comprising chromium complexes having tris(pyrazol-1-yl)methane ligands.

US 2005/0113622 (equivalent to WO 2005/039758) discloses Cr based trimerization catalysts.

Additional catalysts useful for oligomerizing olefins include those disclosed in U.S. Ser. No. 11/371,614; filed Mar. 9, 2006; U.S. Ser. No. 11/371,983, filed Mar. 9, 2006; and U.S. Ser. No. 60/841,226, filed Aug. 30, 2006.

Other pertinent references include J. Am. Chem. Soc. 123, 7423-7424 (2001), WO01/68572A1, WO02/066404A1, WO04/056477, WO04/056478, WO04/056479, WO04/056480, EP1110930A1, U.S. Pat. Nos. 3,333,016, 5,439,862, 5,744,677, and 6,344,594 and U.S. Pat. App. Pub. No. 2002/0035029A1.

Although each of the above described catalysts are useful for the dimerization or trimerization of ethylene, there remains a desire to improve the performance of olefin oligomerization catalysts from the standpoint of productivity and selectivity for oligomers such as 1-butene, 1-hexene and 1-octene.

What is needed is a catalyst system that can be readily prepared and that selectively oligomerizes ethylene or other olefins with both high activity and high selectivity to desired oligomers such as 1-butene, 1-hexene or 1-octene.

### SUMMARY OF THE INVENTION

The present invention provides methods, catalysts and compositions to produce oligomers of olefins, comprising reacting olefins with a catalyst system under oligomerization conditions. The oligomerization reaction can have a selectivity of at least 70 mole percent for the desired oligomer. In particular, the present invention provides methods, catalysts and compositions to produce dimers of olefins, and in particular to the dimerization of ethylene to butene, and in particular to the selective dimerization of ethylene to 1-butene. Typically the catalyst system is formed from the combination of:

(1) a ligand characterized by the following general formula:

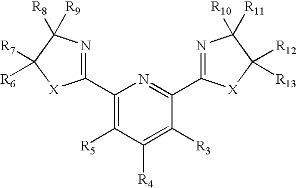

wherein R₃, R₄ and R₅ are independently selected from the group consisting of hydrogen, halogen, nitro, and optionally substituted alkyl, heteroalkyl, aryl, heteroaryl, alkoxy, aryloxy, silyl, boryl, phosphino, amino, alkylthio, arylthio, and combinations thereof, and optionally two or more R³, R⁴ and R⁵ groups may be joined to form one or more optionally substituted ring systems;

R₆, R₇, R₈, R₉, R₁₀, R₁₁, R₁₂ and R₁₃ are each individually selected from the group consisting of optionally substituted hydrocarbyl, heteroatom containing hydrocarbyl and hydrogen, optionally two or more R₆, R₇, R₈ and R₉ groups may be joined to form one or more optionally substituted ring systems and optionally two or more R₁₀, R₁₁, R₁₂ and R₁₃ groups may be joined to form one or more optionally substituted ring systems;

X is O or S;

(2) a metal precursor compound characterized by the general formula Cr(L)ₙ where each L is independently selected from the group consisting of halide, alkyl, substituted alkyl, cycloalkyl, substituted cycloalkyl, heteroalkyl, substituted heteroalkyl heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, ether, thioether, carboxylates, thio, 1,3-dionates, oxalates, carbonates, nitrates, sulfates, ethers, thioethers and combinations thereof, wherein two or more L groups may be combined in a ring structure having from 3 to 50 non-hydrogen atoms; n is 1, 2, 3, 4, 5, or 6; and

(3) optionally, one or more activators.

In one embodiment, R₆, R₇, R₈, R₉, R₁₀, R₁₁, R₁₂ and R₁₃ are each independently selected from the group consisting of optionally substituted alkyl, aryl, heteroaryl and hydrogen.

In another embodiment, one of R₈ or R₉ and one of R₁₀ or R₁₁ are not isopropyl. In another embodiment, all of R₈, R₉, R₁₀ and R₁₁ are not isopropyl.

In yet another embodiment, one of R₈ or R₉ and one of R₁₀ or R₁₁ is optionally substituted aryl or heteroaryl.

In yet another embodiment, one of R₈ or R₉ and one of R₁₀ or R₁₁ is optionally substituted aryl and R₆, R₇, R₁₂ and R₁₃ are each hydrogen.

In yet another embodiment, one of R₈ or R₉ and one of R₁₀ or R₁₁ is phenyl and R₆, R₇, R₁₂ and R₁₃ are each hydrogen.

In yet another embodiment, the ligand is selected from the group consisting of ligands A1 through A18 depicted in FIGS. 1 through 3.

It should be understood by one skilled in the art that the ligands of the invention may include one or more chiral centers and as a consequence may exist as stereoisomers, enantiomers and diastereomers and mixtures thereof, such as racemic mixtures. As the various compound names, formulae and compound drawings within the specification and claims can represent only one of the conformational isomeric, optical isomeric or geometric isomeric forms, it should be understood that the invention encompasses any tautomeric, conformational isomeric, optical isomeric and/or geometric isomeric forms of the compounds having one or more of the utilities described herein, as well as mixtures of these various different isomeric forms. In cases of limited rotation around the pyridine core structure, atropisomers are also possible and are also specifically included in the compounds of the invention.

In some embodiments the activator used in the method of the present invention can be selected from the group consisting of modified methylalumoxane (MMAO), methylalumoxane (MAO), trimethylaluminum (TMA), triisobutyl aluminum (TIBA), polymethylalumoxane-IP (PMAO-IP), N,N-di(n-decyl)-4-n-butyl-anilinium tetrakis(perfluorophenyl)borate, and mixtures thereof.

In some embodiments the metal precursor used in the method of the present invention can be selected from the group consisting of (THF)₃CrMeCl₂, (THF)₃CrCl₃, (Mes)₃Cr(THF), (THF)₃CrPh₃, [{TFA}₂Cr(OEt₂)]₂, (Mes)₂Cr(THF)₃, (Mes)₂Cr(THF), (Mes)CrCl(THF)₂, (Mes)CrCl(THF)_{0.5}, CrCl₂, CrCl₂(THF), (THF)₃Cr(η²-2,2′-Biphenyl)Br, and mixtures thereof.

The method of the present invention can oligomerize, e.g. dimerize, C₂ to C₁₂ olefins. In one embodiment of the present invention, the olefin can be ethylene. The oligomerization or ethylene can produce 1-butene, 2-butene, or mixtures thereof. The reaction in the method of the present invention can occur in a hydrocarbon solvent.

Further aspects of this invention will be evident to those of skill in the art upon review of this specification.

### BRIEF DESCRIPTION OF THE DRAWINGS

FIG. 1 illustrates ligands A1-A8 according to embodiments of the invention.

FIG. 2 illustrates ligands A9-A16 according to embodiments of the invention.

FIG. 3 illustrates ligands A17 and A18 according to embodiments of the invention.

### DETAILED DESCRIPTION

The inventions disclosed herein include chromium metal complexes and compositions, which are useful as catalysts for the selective oligomerization of olefins, specifically C2 to C12 olefins and especially C2 to C8 olefins, including the dimerization of ethylene.

For the purposes of this invention and the claims thereto when an oligomeric material (such as a dimer, trimer, or tetramer) is referred to as comprising an olefin, the olefin present in the material is the reacted form of the olefin. Likewise, the active species in a catalytic cycle may comprise the neutral or ionic forms of the catalyst. In addition, a reactor is any container(s) in which a chemical reaction occurs.

As used herein, the new numbering scheme for the Periodic Table Groups is used as set out in CHEMICAL AND ENGINEERING NEWS, 63(5), 27 (1985).

As used herein, the phrase “characterized by the formula” is not intended to be limiting and is used in the same way that “comprising” is commonly used. The term “independently selected” is used herein to indicate that the groups in question—e.g., R₁, R₂, R₃, R₄, and R₅—can be identical or different (e.g., R₁, R₂, R₃, R₄, and R₅ may all be substituted alkyls, or R₁ and R₂ may be a substituted alkyl and R₃ may be an aryl, etc.). Use of the singular includes use of the plural and vice versa (e.g., a hexane solvent, includes hexanes). A named R group will generally have the structure that is recognized in the art as corresponding to R groups having that name. The terms “compound” and “complex” are generally used interchangeably in this specification, but those of skill in the art may recognize certain compounds as complexes and vice versa. In addition, the term “catalyst” will be understood by those of skill in the art to include either activated or unactivated forms of the molecules the comprise the catalyst, for example, a procatalyst and including complexes and activators or compositions of ligands, metal precursors and activators and optionally including scavengers and the like. For purposes of this invention, a catalyst system is defined to be the combination of an activator and a metal ligand complex or the combination of an activator, a ligand and a metal precursor. A metal ligand complex is defined to be the product of the combination of a metal precursor and a ligand. For the purposes of illustration, representative certain groups are defined herein. These definitions are intended to supplement and illustrate, not preclude, the definitions known to those of skill in the art.

“Optional” or “optionally” means that the subsequently described event or circumstance may or may not occur, and that the description includes instances where the event or circumstance occurs and instances where it does not. For example, the phrase “optionally substituted hydrocarbyl” means that a hydrocarbyl moiety may or may not be substituted and that the description includes both unsubstituted hydrocarbyl and hydrocarbyl where there is substitution.

The term “substituted” as in “substituted hydrocarbyl,” “substituted aryl,” “substituted alkyl,” and the like, means that in the group in question (i.e., the hydrocarbyl, alkyl, aryl or other moiety that follows the term), at least one hydrogen atom bound to a carbon atom is replaced with one or more substituent groups such as hydroxy, alkoxy, alkylthio, phosphino, amino, halo, silyl, and the like. When the term “substituted” introduces a list of possible substituted groups, it is intended that the term apply to every member of that group. That is, the phrase “substituted alkyl, alkenyl and alkynyl” is to be interpreted as “substituted alkyl, substituted alkenyl and substituted alkynyl.” Similarly, “optionally substituted alkyl, alkenyl and alkynyl” is to be interpreted as “optionally substituted alkyl, optionally substituted alkenyl and optionally substituted alkynyl.”

The term “saturated” refers to the lack of double and triple bonds between atoms of a radical group such as ethyl, cyclohexyl, pyrrolidinyl, and the like. The term “unsaturated” refers to the presence of one or more double and triple bonds between atoms of a radical group such as vinyl, allyl, acetylide, oxazolinyl, cyclohexenyl, acetyl and the like, and specifically includes alkenyl and alkynyl groups, as well as groups in which double bonds are delocalized, as in aryl and heteroaryl groups as defined below.

The terms “cyclo” and “cyclic” are used herein to refer to saturated or unsaturated radicals containing a single ring or multiple condensed rings. Suitable cyclic moieties include, for example, cyclopentyl, cyclohexyl, cyclooctenyl, bicyclooctyl, phenyl, naphthyl, pyrrolyl, furyl, thiophenyl, imidazolyl, and the like. In particular embodiments, cyclic moieties include between 3 and 200 atoms other than hydrogen, between 3 and 50 atoms other than hydrogen or between 3 and 20 atoms other than hydrogen.

The term “hydrocarbyl” as used herein refers to hydrocarbyl radicals containing 1 to about 50 carbon atoms, specifically 1 to about 24 carbon atoms, most specifically 1 to about 16 carbon atoms, including branched or unbranched, cyclic or acyclic, saturated or unsaturated species, such as alkyl groups, alkenyl groups, aryl groups, and the like.

The term “alkyl” as used herein refers to a branched or unbranched saturated hydrocarbon group typically although not necessarily containing 1 to about 50 carbon atoms, such as methyl, ethyl, n-propyl, isopropyl, n-butyl, isobutyl, sec-butyl, t-butyl, octyl, decyl, and the like, as well as cycloalkyl groups such as cyclopentyl, cyclohexyl and the like. Generally, although again not necessarily, alkyl groups herein may contain 1 to about 20 carbon atoms.

The term “alkenyl” as used herein refers to a branched or unbranched, cyclic or acyclic hydrocarbon group typically, although not necessarily, containing 2 to about 50 carbon atoms and at least one double bond, such as ethenyl, n-propenyl, isopropenyl, n-butenyl, isobutenyl, octenyl, decenyl, and the like. Generally, although again not necessarily, alkenyl groups herein contain 2 to about 20 carbon atoms.

The term “alkynyl” as used herein refers to a branched or unbranched, cyclic or acyclic hydrocarbon group typically although not necessarily containing 2 to about 50 carbon atoms and at least one triple bond, such as ethynyl, n-propynyl, isopropynyl, n-butynyl, isobutynyl, octynyl, decynyl, and the like. Generally, although again not necessarily, alkynyl groups herein may have 2 to about 20 carbon atoms.

The term “aromatic” is used in its usual sense, including unsaturation that is essentially delocalized across several bonds around a ring. The term “aryl” as used herein refers to a group containing an aromatic ring. Aryl groups herein include groups containing a single aromatic ring or multiple aromatic rings that are fused together, linked covalently, or linked to a common group such as a methylene or ethylene moiety. More specific aryl groups contain one aromatic ring or two or three fused or linked aromatic rings, e.g., phenyl, naphthyl, biphenyl, anthracenyl, or phenanthrenyl. In particular embodiments, aryl substituents include 1 to about 200 atoms other than hydrogen, typically 1 to about 50 atoms other than hydrogen, and specifically 1 to about 20 atoms other than hydrogen. In some embodiments herein, multi-ring moieties are substituents and in such embodiments the multi-ring moiety can be attached at an appropriate atom. For example, “naphthyl” can be 1-naphthyl or 2-naphthyl; “anthracenyl” can be 1-anthracenyl, 2-anthracenyl or 9-anthracenyl; and “phenanthrenyl” can be 1-phenanthrenyl, 2-phenanthrenyl, 3-phenanthrenyl, 4-phenanthrenyl, or 9-phenanthrenyl.

The term “alkoxy” as used herein intends an alkyl group bound through a single, terminal ether linkage; that is, an “alkoxy” group may be represented as —O-alkyl where alkyl is as defined above. The term “aryloxy” is used in a similar fashion, and may be represented as —O-aryl, with aryl as defined below. The term “hydroxy” refers to —OH.

Similarly, the term “alkylthio” as used herein intends an alkyl group bound through a single, terminal thioether linkage; that is, an “alkylthio” group may be represented as —S-alkyl where alkyl is as defined above. The term “arylthio” is used similarly, and may be represented as —S-aryl, with aryl as defined below. The term “mercapto” refers to —SH.

The terms “halo” and “halogen” are used in the conventional sense to refer to a chloro, bromo, fluoro or iodo radical.

The terms “heterocycle” and “heterocyclic” refer to a cyclic radical, including ring-fused systems, including heteroaryl groups as defined below, in which one or more carbon atoms in a ring is replaced with a heteroatom—that is, an atom other than carbon, such as nitrogen, oxygen, sulfur, phosphorus, boron or silicon. Heterocycles and heterocyclic groups include saturated and unsaturated moieties, including heteroaryl groups as defined below. Specific examples of heterocycles include pyridine, pyrrolidine, pyrroline, furan, tetrahydrofuran, thiophene, imidazole, oxazole, thiazole, indole, and the like, including any isomers of these. Additional heterocycles are described, for example, in Alan R. Katritzky, Handbook of Heterocyclic Chemistry, Pergammon Press, 1985, and in Comprehensive Heterocyclic Chemistry, A. R. Katritzky et al., eds., Elsevier, 2d. ed., 1996. The term “metallocycle” refers to a heterocycle in which one or more of the heteroatoms in the ring or rings is a metal.

The term “heteroaryl” refers to an aryl radical that includes one or more heteroatoms in the aromatic ring. Specific heteroaryl groups include groups containing heteroaromatic rings such as thiophene, pyridine, pyrazine, isoxazole, pyrazole, pyrrole, furan, thiazole, oxazole, imidazole, isothiazole, oxadiazole, triazole, and benzo-fused analogues of these rings, such as indole, carbazole, benzofuran, benzothiophene and the like.

More generally, the modifiers “hetero” and “heteroatom-containing”, as in “heteroalkyl” or “heteroatom-containing hydrocarbyl group” refer to a molecule or molecular fragment in which one or more carbon atoms is replaced with a heteroatom. Thus, for example, the term “heteroalkyl” refers to an alkyl substituent that is heteroatom-containing. When the term “heteroatom-containing” introduces a list of possible heteroatom-containing groups, it is intended that the term apply to every member of that group. That is, the phrase “heteroatom-containing alkyl, alkenyl and alkynyl” is to be interpreted as “heteroatom-containing alkyl, heteroatom-containing alkenyl and heteroatom-containing alkynyl.”

By “divalent” as in “divalent hydrocarbyl”, “divalent alkyl”, “divalent aryl” and the like, is meant that the hydrocarbyl, alkyl, aryl or other moiety is bonded at two points to atoms, molecules or moieties with the two bonding points being covalent bonds.

As used herein the term “silyl” refers to the —SiZ¹Z²Z³ radical, where each of Z¹, Z², and Z³ is independently selected from the group consisting of hydrogen and optionally substituted alkyl, alkenyl, alkynyl, heteroatom-containing alkyl, heteroatom-containing alkenyl, heteroatom-containing alkynyl, aryl, heteroaryl, alkoxy, aryloxy, amino, silyl and combinations thereof.

As used herein the term “boryl” refers to the —BZ¹Z² group, where each of Z¹ and Z² is as defined above. As used herein, the term “phosphino” refers to the group —PZ¹Z², where each of Z¹ and Z² is as defined above. As used herein, the term “phosphine” refers to the group :PZ¹Z²Z³, where each of Z¹, Z³ and Z² is as defined above. The term “amino” is used herein to refer to the group —NZ¹Z², where each of Z¹ and Z² is as defined above. The term “amine” is used herein to refer to the group :NZ¹Z²Z³, where each of Z¹, Z² and Z³ is as defined above.

Throughout the Figures and the following text, several abbreviations may be used to refer to specific compounds or elements. Abbreviations for atoms are as given in the periodic table (Li=lithium, for example). Other abbreviations that may be used are as follows: “i-Pr” to refer to isopropyl; “t-Bu” to refer to tertiary-butyl; “i-Bu” to refer to isobutyl; “Me” to refer to methyl; “Et” to refer to ethyl; “Ph” to refer to phenyl; “Mes” to refer to mesityl (2,4,6-trimethyl phenyl); “TFA” to refer to trifluoroacetate; “THF” to refer to tetrahydrofuran; “TsOH” to refer to para-toluenesulfonic acid; “cat.” to refer to catalytic amount of; “LDA” to refer to lithium diisopropylamide; “DMF” to refer to dimethylformamide; “eq.” to refer to molar equivalents; “TMA” to refer to AlMe₃; “TIBA” to refer to Al(i-Bu)₃. SJ2BF₂₀ refers to [(n-C₁₀H₂₁)₂(4-n-C₄H₉—C₆H₄)NH][B(C₆F₅)₄].

This invention relates to methods for selectively oligomerizing (e.g., dimerizing) C₂ to C₁₂ olefins, specifically ethylene, comprising reacting a catalytic composition or compound(s), optionally with one or more activators, with the olefin. As referred to herein, selective oligomerization refers to producing the desired oligomer with a selectivity of the reaction being at least 70%, more specifically at least 80% by mole of oligomer, with the possibility that an acceptable amount of polymer is present, but with the preference that no polymer is present in the product. In other embodiments, less than 20 weight % of polymer is present, specifically less than 5 weight %, more specifically less than 2 weight %, based upon the total weight of monomer converted to oligomers and polymers, where a polymer is defined to mean a molecule comprising more than 100 mers. In other embodiments, selective oligomerization refers to producing two desired oligomers, with the selectivity of the two desired oligomers summing to at least 80% by sum of mole of oligomers.

In another embodiment, this invention relates to a method to dimerize a C₂ to C₁₂ olefin wherein the method produces at least 70% selectivity for the desired oligomer(s) (specifically at least 80%, specifically at least 85%, specifically at least 90%, specifically at least 95%, specifically at least 98%, specifically at least 99%, specifically 100%), calculated based upon the amount of the desired oligomer produced relative to the total yield of product(s); and at least 70% of the olefin monomer reacts to form product (specifically at least 80%, specifically at least 85%, specifically at least 90%, specifically at least 95%, specifically at least 98%, specifically at least 99%, specifically 100%).

This invention also relates to novel metal ligand complexes and or novel combinations of specific ligands disclosed herein and metal precursors.

The methods of this invention specifically contact the desired monomers with a metal ligand complex or a combination of a ligand and a metal precursor (and optional activators) to form the desired oligomer. In particular, ligands useful in the present invention may be characterized by the general formula:

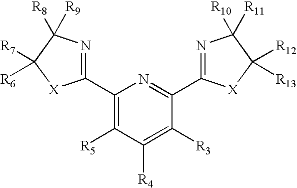

wherein R₃, R₄ and R₅ are independently selected from the group consisting of hydrogen, halogen, nitro, and optionally substituted alkyl, heteroalkyl, aryl, heteroaryl, alkoxy, aryloxy, silyl, boryl, phosphino, amino, alkylthio, arylthio, and combinations thereof, and optionally two or more R³, R⁴ and R⁵ groups may be joined to form one or more optionally substituted ring systems;

R₆, R₇, R₈, R₉, R₁₀, R₁₁, R₁₂ and R₁₃ are each individually selected from the group consisting of optionally substituted hydrocarbyl, heteroatom containing hydrocarbyl and hydrogen, optionally two or more R₆, R₇, R₈ and R₉ groups may be joined to form one or more optionally substituted ring systems and optionally two or more R₁₀, R₁₁, R₁₂ and R₁₃ groups may be joined to form one or more optionally substituted ring systems; and

X is O or S.

In one embodiment, R₆, R₇, R₈, R₉, R₁₀, R₁₁, R₁₂ and R₁₃ are each independently selected from the group consisting of optionally substituted alkyl, aryl, heteroaryl and hydrogen.

In another embodiment, one of R₈ or R₉ and one of R₁₀ or R₁₁ is not isopropyl.

In yet another embodiment, one of R₈ or R₉ and one of R₁₀ or R₁₁ is optionally substituted aryl or heteroaryl.

In yet another embodiment, one of R₈ or R₉ and one of R₁₀ or R₁₁ is optionally substituted aryl and R₆, R₇, R₁₂ and R₁₃ are each hydrogen.

In yet another embodiment, one of R₈ or R₉ and one of R₁₀ or R₁₁ is phenyl and R₆, R₇, R₁₂ and R₁₃ are each hydrogen.

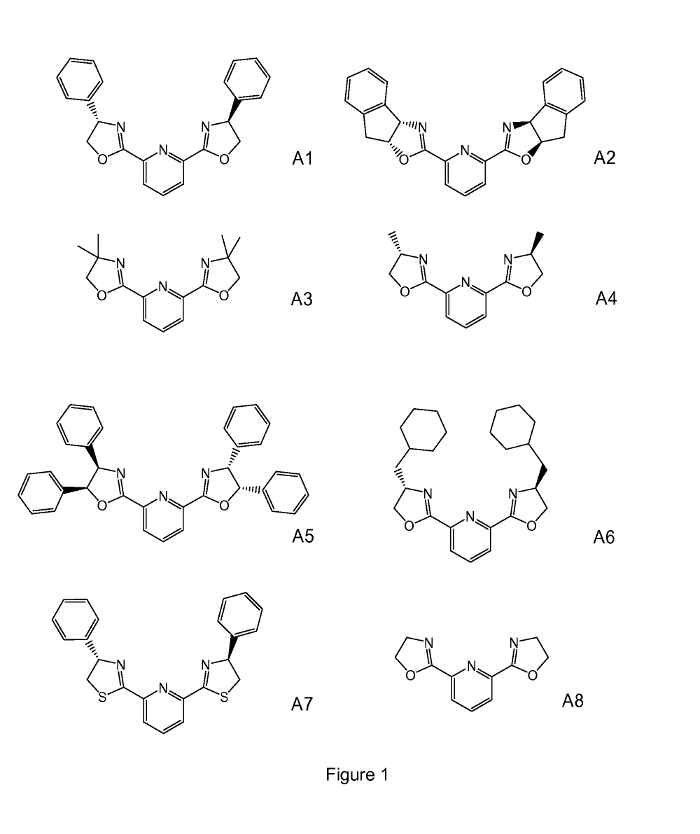

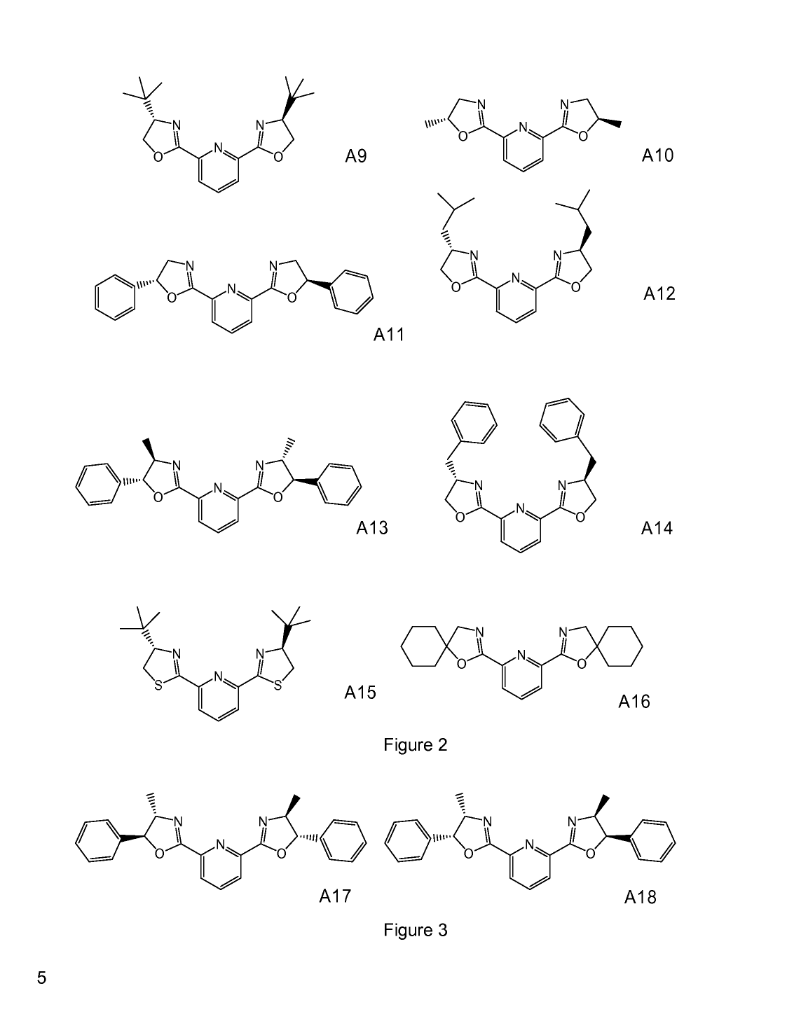

In yet another embodiment, the ligand is selected from the group consisting of ligands A1 through A18 depicted in FIGS. 1 through 3.

The detailed synthesis of certain types of pyridine bis(oxazoline) ligands and pyridine bisthiazoline ligands are specifically described below. Those of ordinary skill in the art will be able to synthesize other embodiments. Many pyridine bis(oxazoline) ligands may also be purchased commercially, for example from Aldrich Chemical Company, Milwaukee, Wis., USA, or Strem Chemicals, Inc., Newburyport, Mass., USA.

Pyridine bis(oxazoline) ligands may also be prepared according to the procedures known to those of ordinary skill in the art as illustrated by the reaction scheme given in Scheme 1 where R₃, R₄, R₅, R₆, R₇, R₈, R₉, R₁₀, R₁₁, R₁₂, and R₁₃ are as defined above.

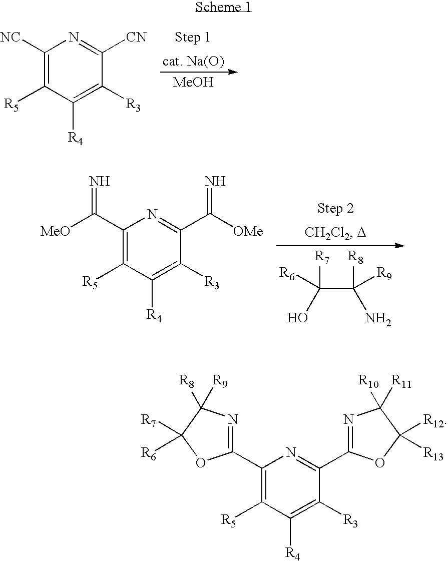

The reaction to produce a pyridyl bis(oxazoline) ligand can be performed in two general reaction steps. In the first step, a suitably substituted 2,6-dicyanopyridine is converted to the corresponding 2,6-diimidate by basic alcoholysis. Step 2 converts the resulting diimidate into the bis(oxazoline) by reaction with a suitably substituted β-aminoalcohol.

Pyridine bisthiazoline ligands may be prepared according to the procedures known to those of ordinary skill in the art as illustrated by the reaction scheme given in Scheme 2 where R₃, R₄, R₅, R₆, R₇, R₈, R₉, R₁₀, R₁₁, R₁₂, and R₁₃ are as defined above.

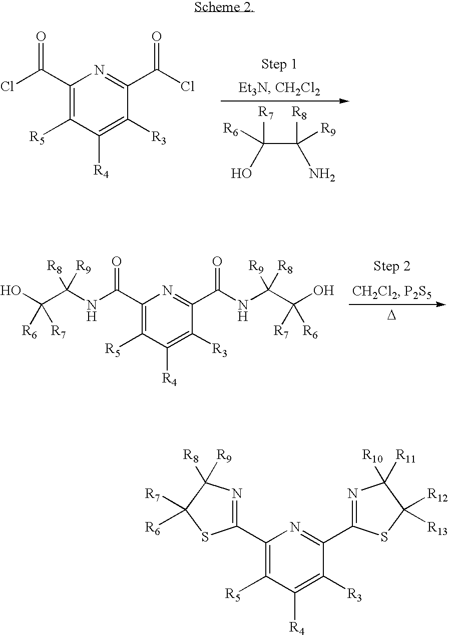

The reaction to produce a pyridyl bisthiazoline ligand can be performed in two general steps. In the first step, a diamide is formed by the addition of a suitably substituted β-aminoalcohol to a suitably substituted pyridine 2,6-diacid chloride. The resulting diamide is then thiodehydrated with concomitant cyclization to yield the pyridine bisthiazoline.

Once the desired ligand is formed, it can be combined with a Cr atom, ion, compound or other Cr precursor compound, and in some embodiments the present invention encompasses compositions that include any of the above-mentioned ligands in combination with a Cr precursor and an optional activator. For example, in some embodiments, the Cr precursor can be an activated Cr precursor, which refers to a Cr precursor (described below) that has been combined or reacted with an activator (described below) prior to combination or reaction with the ancillary ligand. As noted above, in one aspect the invention provides compositions that include such combinations of ligand and Cr atom, ion, compound or precursor. In some applications, the ligands are combined with a Cr compound or precursor and the product of such combination is not determined, if a product forms. For example, the ligand may be added to a reaction vessel at the same time as the Cr precursor compound along with the reactants, activators, scavengers, etc. Additionally, the ligand can be modified prior to addition to or after the addition of the Cr precursor, e.g., through a deprotonation reaction or some other modification.

The Cr metal precursor compounds may be characterized by the general formula Cr(L)ₙ where L is an organic group, an inorganic group, or an anionic atom; and n is an integer of 1 to 6, and when n is not less than 2, L may be the same or different from each other. Each L is a ligand independently selected from the group consisting of hydrogen, halogen, optionally substituted alkyl, heteroalkyl, allyl, diene, alkenyl, heteroalkenyl, alkynyl, heteroalkynyl, aryl, heteroaryl, alkoxy, aryloxy, boryl, silyl, amino, phosphino, ether, thioether, phosphine, amine, carboxylate, alkylthio, arylthio, 1,3-dionate, oxalate, carbonate, nitrate, sulfate, and combinations thereof. Optionally, two or more L groups may be joined into a ring structure. One or more of the ligands L may be ionically bonded to Cr and, for example, L may be a non-coordinated or loosely coordinated or weakly coordinated anion (e.g., L may be selected from the group consisting of those anions described below in the conjunction with the activators). See Marks et al., Chem. Rev. 100, pp 1391-1434 (2000) and references therein for a detailed discussion of these weak interactions. The chromium precursors may be monomeric, dimeric or higher orders thereof.

Specific examples of suitable chromium precursors include, but are not limited to (THF)₃CrMeCl₂, (Mes)₃Cr(THF) (Mes=mesityl=2,4,6-trimethylphenyl), [{TFA}₂Cr(OEt₂)]₂ (TFA=trifluoroacetate), (THF)₃CrPh₃, CrCl₃(THF)₃, CrCl₄(NH₃)₂, Cr(NMe₃)₂Cl₃, CrCl₃, Cr(acac)₃ (acac=acetylacetonato), Cr(2-ethylhexanoate)₃, Cr(neopentyl)₄, Cr(CH₂—C₆H₄-o-NMe₂)₃, Cr(TFA)₃, Cr(CH(SiMe₃)₂)₃, Cr(Mes)₂(THF)₃, Cr(Mes)₂(THF), Cr(Mes)Cl(THF)₂, Cr(Mes)Cl(THF)_{0.5}, Cr(p-tolyl)Cl₂(TH F)₃, Cr(diisopropylamide)₃, Cr(picolinate)₃, [Cr₂Me₈][Li(THF)]₄, CrCl₂(THF), Cr(NO₃)₃, [CrMe₆][Li(Et₂O)]₃, [CrPh₆][Li(THF)]₃, [CrPh₆][Li(n-Bu₂O)]₃, [Cr(C₄H₈)₃][Li(THF)]₃, CrCl₂, Cr(hexafluoroacetylacetonato)₃, (THF)₃Cr(η²-2,2′-Biphenyl)Br and mixtures thereof.

The ligand may be mixed with a suitable metal precursor compound prior to or simultaneously with allowing the mixture to be contacted with the reactants (e.g., monomers). In this context, the ligand to metal precursor compound ratio can be in the range of about 0.1:1 to about 10:1, more specifically in the range of about 0.5:1 to about 2:1, and even more specifically about 1:1.

Generally, the ligand (or optionally a modified ligand as discussed above) is mixed with a suitable Cr precursor (and optionally other components, such an activator, or a reagent to exchange L groups on the chromium after contact between the chromium precursor and the ligand; e.g., Li(acac)) prior to or simultaneously with allowing the mixture to be contacted with the reactants (e.g., monomers). When the ligand is mixed with the Cr precursor compound, a Cr-ligand complex may be formed, which may itself be an active catalyst or may be transformed into a catalyst upon activation. In some embodiments the Cr precursor is contacted with other ligands, then activators, then monomers. In other embodiments the activators or other reactants are added to the reaction mixtures after contacting the Cr precursor with the ligands and monomers. Other orders of addition of the various components in the oligomerization reactions described herein will be understood by one of skill in the art.

Cr-ligand complexes can take a number of different coordination modes. General examples of possible coordination modes include those characterized by the following general formulas:

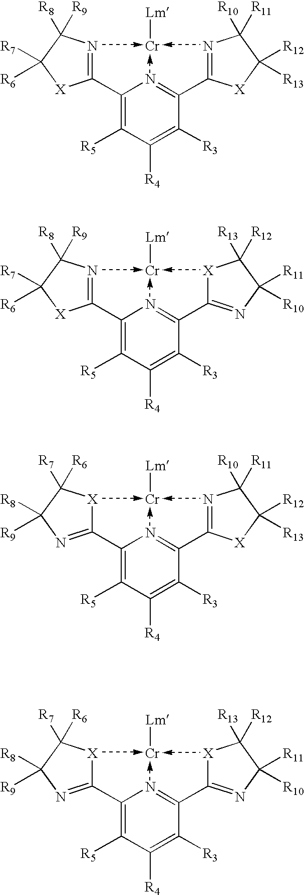

wherein R₃, R₄, R₅, R₆, R₇, R₈, R₉, R₁₀, R₁₁, R₁₂, R₁₃, X and L are as described above; m′ is the number of L present and is equal to 1, 2, 3, 4, or 5; and a dashed arrow indicates an optional dative bond which may or may not be present, provided that at least one of the three optional dative bonds is present as a dative bond between the ligand and the Cr. One of skill in the art will recognize the possibility of additional modes of binding ligands of this invention to Cr arising from, for example, ortho-metallation of an arene substituent on the ligand. Many other coordination modes are possible, for example the L ligands may bind to two chromium metal centers in a bridging fashion (see for example Cotton and Walton, Multiple Bonds Between Metal Atoms 1993, Oxford University Press) as shown below where A is the ligand of the invention in one of the coordination modes shown above; the dashed line indicates that a metal-metal bond may or may not be present; L is as described above and where m″ is the number of bridging L present and m′″ the number of non-bridging L present; m″=1, 2, 3 or 4; and m′″=0, 1, 2, 3, or 4, provided that the sum of m″ and m′″ is 1, 2, 3, 4, or 5.

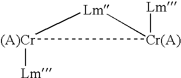

Specific embodiments of bridged dimeric complexes include:

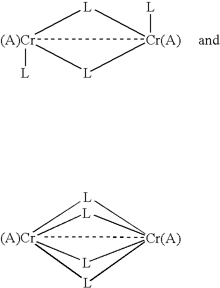

The ligands of the invention may also bind to two chromium metal centers in a bridging fashion as shown below where A is the ligand of the invention; L is described above and m′ is the number of bridging ligands A and is equal to 1, 2, 3 or 4; m″=0, 1, 2 or 3; and m′″=0, 1, 2 or 3 provided that the sum of m′, m″, and m′″ is 3, 4, 5, 6, or 7.

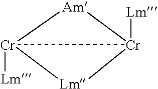

In some embodiments, the ligand will be mixed with a suitable metal precursor prior to or simultaneous with allowing the mixture to be contacted to the reactants. When the ligand is mixed with the metal precursor, a metal-ligand complex may be formed. In connection with the metal-ligand complex and depending on the ligand or ligands chosen, the metal-ligand complex may take the form of monomeric complexes, dimers, trimers or higher orders thereof or there may be two or more metal atoms that are bridged by one or more ligands. Furthermore, two or more ligands may coordinate to a single metal atom. The exact nature of the metal-ligand complex(es) formed depends on the chemistry of the ligand and the method of combining the metal precursor and ligand, such that a distribution of metal-ligand complexes may form with the number of ligands bound to the metal being greater than, equal to or less than the number of equivalents of ligands added relative to an equivalent of metal precursor. The ligand may, in some embodiments, be modified on binding to the metal, for example through a C—H activation reaction leading to a Cr-carbon bond, such as, for example, ortho-metallation of an arene moiety. Also, in some embodiments the ligand may be modified upon activation of the complex, for example through alkylation of a carbon of a C═N double bond & formation of a Cr—N covalent bond or reaction on the pyridine ring (for example, at positions R₃, R₄ or R₅). In further embodiments, a molecule of ethylene or another olefin (for example, 1-butene) may insert into the aforementioned ortho-metallated arene

In addition, the catalyst systems of this invention may be combined with other catalysts in a single reactor and/or employed in a series of reactors (parallel or serial).

The ligands-metal-precursor combinations and the metal ligand complexes, described above, are optionally activated in various ways to yield compositions active for selective ethylene oligomerization. For the purposes of this patent specification and appended claims, the terms “cocatalyst” and “activator” are used herein interchangeably and are defined to be any compound which can activate any one of the ligand-metal-precursor-combinations or the metal ligand complexes, described above by converting the combination, complex, or composition into a catalytically active species. Non-limiting activators, for example, include alumoxanes, aluminum alkyls, other metal or main group alkyl or aryl compounds, ionizing activators, which may be neutral or ionic, Lewis acids, reducing agents, oxidizing agents, and combinations thereof.

In one embodiment, alumoxane activators are utilized as an activator in the compositions useful in the invention. Alumoxanes are generally oligomeric compounds containing —Al(R*)—O— sub-units, where R* is an alkyl group. Examples of alumoxanes include methylalumoxane (MAO), ethylalumoxane, isobutylalumoxane, and modified methylalumoxanes (MMAO), which include alkyl groups other than methyl such as ethyl, isobutyl, and n-octyl, such as MMAO-3A, PMAO-IP (the latter referring to polymethylalumoxane-IP, manufactured by Akzo-Nobel and meaning an MAO prepared from a non-hydrolytic process). Alkylalumoxanes and modified alkylalumoxanes are suitable as catalyst activators, particularly when the abstractable ligand of the catalyst is a halide, alkoxide or amide. Mixtures of different alumoxanes and modified alumoxanes may also be used.

The activator compounds comprising Lewis-acid activators and in particular alumoxanes are specifically characterized by the following general formulae:

(R^{a}—Al—O)ₚ

R^{b}(R^{c}—Al—O)ₚ—AlR^{e}₂

where R^{a}, R^{b}, R^{c} and R^{e} are, independently a C₁-C₃₀ alkyl radical, for example, methyl, ethyl, propyl, butyl, pentyl, hexyl, heptyl, octyl, nonyl, decyl, and “p” is an integer from 1 to about 50. Most specifically, R^{a}, R^{b}, R^{c} and R^{d} are each methyl and “p” is a least 4. When an alkyl aluminum halide or alkoxide is employed in the preparation of the alumoxane, one or more R^{a}, R^{b}, R^{c} or R^{e} are groups may be halide or alkoxide.

It is recognized that alumoxane is not a discrete material. An alumoxane is generally a mixture of both the linear and cyclic compounds. A typical alumoxane will contain free trisubstituted or trialkyl aluminum, bound trisubstituted or trialkyl aluminum, and alumoxane molecules of varying degree of oligomerization. For some embodiments, it is preferred that methylalumoxanes contain lower levels of trimethylaluminum. Lower levels of trimethylaluminum can be achieved by reaction of the trimethylaluminum with a Lewis base or by vacuum distillation of the trimethylaluminum or by any other means known in the art.

For further descriptions, see U.S. Pat. Nos. 4,665,208, 4,952,540, 5,041,584, 5,091,352, 5,206,199, 5,204,419, 4,874,734, 4,924,018, 4,908,463, 4,968,827, 5,329,032, 5,248,801, 5,235,081, 5,157,137, 5,103,031 and EP0561476A1, EP0279586B1, EP0516476A1, EP0594218A1 and WO94/10180.

When the activator is an alumoxane (modified or unmodified), some embodiments select the maximum amount of activator at a 5000-fold molar excess Al/Cr over the catalyst precursor. The minimum preferred activator-to-catalyst-precursor is a 1:1 molar ratio. More specifically, the Al/Cr ratio is from 1000:1 to 100:1.

Alumoxanes may be produced by the hydrolysis of the respective trialkylaluminum compound. MMAO may be produced by the hydrolysis of trimethylaluminum and a higher trialkylaluminum such as triisobutylaluminum. MMAO's are generally more soluble in aliphatic solvents and more stable during storage. There are a variety of methods for preparing alumoxane and modified alumoxanes, non-limiting examples of which are described in U.S. Pat. Nos. 4,665,208, 4,952,540, 5,091,352, 5,206,199, 5,204,419, 4,874,734, 4,924,018, 4,908,463, 4,968,827, 5,308,815, 5,329,032, 5,248,801, 5,235,081, 5,157,137, 5,103,031, 5,391,793, 5,391,529, 5,693,838, 5,731,253, 5,731,451, 5,744,656, 5,847,177, 5,854,166, 5,856,256 and 5,939,346 and European publications EP0561476A1, EP0279586B1, EP0594218A1 and EP0586665B1, and PCT publications WO94/10180 and WO99/15534, all of which are herein fully incorporated by reference. It may be preferable to use a visually clear methylalumoxane. A cloudy or gelled alumoxane can be filtered to produce a clear solution or clear alumoxane can be decanted from the cloudy solution. Another useful alumoxane is a modified methyl alumoxane (MMAO) cocatalyst type 3A (commercially available from Akzo Chemicals, Inc. under the trade name Modified Methylalumoxane type 3A, covered under patent number U.S. Pat. No. 5,041,584).

Aluminum alkyl or organoaluminum compounds which may be utilized as activators (or scavengers) include trimethylaluminum, triethylaluminum, triisobutylaluminum, tri-n-hexylaluminum, tri-n-octylaluminum, diisobutylaluminum hydride, ethylaluminum dichloride, diethylaluminum chloride, diethylaluminum ethoxide and the like.

### Ionizing Activators

In some embodiments, the activator includes compounds that may abstract a ligand making the metal complex cationic and providing a charge-balancing non-coordinating or weakly coordinating anion. The term “non-coordinating anion” (NCA) means an anion which either does not coordinate to said cation or which is only weakly coordinated to said cation thereby remaining sufficiently labile to be displaced by a Lewis base (for example, a neutral Lewis base).

It is within the scope of this invention to use an ionizing or stoichiometric activator, neutral or ionic, such as tri(n-butyl)ammonium tetrakis(pentafluorophenyl)boron, a tris(pentafluorophenyl)boron metalloid precursor or a tris(heptafluoronaphthyl)boron metalloid precursor, polyhalogenated heteroborane anions (WO98/43983), boric acid (U.S. Pat. No. 5,942,459) or combination thereof. It is also within the scope of this invention to use neutral or ionic activators alone or in combination with alumoxane or modified alumoxane activators.

Examples of neutral stoichiometric activators include tri-substituted boron, tellurium, aluminum, gallium and indium or mixtures thereof. The three substituent groups are each independently selected from alkyls, alkenyls, halogen, substituted alkyls, aryls, arylhalides, alkoxy and halides. In some embodiments, the three groups are independently selected from halogen, mono or multicyclic (including halosubstituted) aryls, alkyls, and alkenyl compounds and mixtures thereof, preferred are alkenyl groups having 1 to 20 carbon atoms, alkyl groups having 1 to 20 carbon atoms, alkoxy groups having 1 to 20 carbon atoms and aryl groups having 3 to 20 carbon atoms (including substituted aryls). In other embodiments, the three groups are alkyls having 1 to 4 carbon groups, phenyl, naphthyl or mixtures thereof. In further embodiments, the three groups are halogenated, specifically fluorinated, aryl groups. In even further embodiments, the neutral stoichiometric activator is tris(perfluorophenyl)boron or tris(perfluoronaphthyl)boron.

Ionic stoichiometric activator compounds may contain an active proton, or some other cation associated with, but not coordinated to, or only loosely coordinated to, the remaining ion of the ionizing compound. Such compounds and the like are described in European publications EP0570982A1, EP0520732A1, EP0495375A1, EP0500944B1, EP0277003A1 and EP0277004A1, and U.S. Pat. Nos. 5,153,157, 5,198,401, 5,066,741, 5,206,197, 5,241,025, 5,384,299 and 5,502,124 and U.S. patent application Ser. No. 08/285,380, filed Aug. 3, 1994, all of which are herein fully incorporated by reference.

Ionic catalysts can be prepared by reacting a Cr compound with some neutral Lewis acids, such as B(C₆F₆)₃, which upon reaction with the abstractable ligand (X) of the Cr compound forms an anion, such as ([B(C₆F₅)₃(X)]⁻), which stabilizes the cationic Cr species generated by the reaction. The catalysts can be prepared with activator components, which are ionic compounds or compositions.

In some embodiments, compounds useful as an activator component in the preparation of the ionic catalyst systems used in the process of this invention comprise a cation, which is optionally a Brönsted acid capable of donating a proton, and a compatible non-coordinating anion which is capable of stabilizing the active catalyst species which is formed when the two compounds are combined and said anion will be sufficiently labile to be displaced by olefinic substrates or other neutral Lewis bases such as ethers, nitriles and the like. Two classes of compatible non-coordinating anions useful herein have been disclosed in EP0277003A1 and EP0277004A1 published 1988: anionic coordination complexes comprising a plurality of lipophilic radicals covalently coordinated to and shielding a central charge-bearing metal or metalloid core; and, anions comprising a plurality of boron atoms such as carboranes, metallacarboranes and boranes.

In one preferred embodiment, the stoichiometric activators include a cation and an anion component, and may be represented by the following formula:

(L-H)_{d}⁺(A^{d-})

where L is a neutral Lewis base; H is hydrogen; (L-H)⁺ is a Brönsted acid; A^{d-} is a non-coordinating anion having the charge d⁻; and d is an integer from 1 to 3.

The cation component, (L-H)_{d}⁺ may include Brönsted acids such as protons or protonated Lewis bases or reducible Lewis acids capable of protonating or abstracting a moiety, such as an alkyl or aryl, from the bulky ligand chromium catalyst precursor, resulting in a cationic transition metal species.

The activating cation (L-H)_{d}⁺ may be a Brönsted acid, capable of donating a proton to the transition metal catalytic precursor resulting in a transition metal cation, including ammoniums, oxoniums, phosphoniums, silyliums, and mixtures thereof, specifically ammoniums of methylamine, aniline, dimethylamine, diethylamine, N-methylaniline, diphenylamine, trimethylamine, triethylamine, N,N-dimethylaniline, methyldiphenylamine, pyridine, p-bromo-N,N-dimethylaniline, p-nitro-N,N-dimethylaniline, phosphoniums from triethylphosphine, triphenylphosphine, and diphenylphosphine, oxoniums from ethers such as dimethyl ether diethyl ether, tetrahydrofuran and dioxane, sulfoniums from thioethers, such as diethyl thioethers and tetrahydrothiophene, and mixtures thereof. The activating cation (L-H)_{d}⁺ may also be a moiety such as silver, tropylium, carbeniums, ferroceniums and mixtures, specifically carboniums and ferroceniums. In one embodiment (L-H)_{d}⁺ can be triphenyl carbonium.

The anion component A^{d-} includes those having the formula [M^{k+}Qₙ]^{d-} wherein k is an integer from 1 to 3; n is an integer from 2-6; n−k=d; M is an element selected from Group 13 of the Periodic Table of the Elements, specifically boron or aluminum, and Q is independently a hydride, bridged or unbridged dialkylamido, halide, alkoxide, aryloxide, hydrocarbyl, substituted hydrocarbyl, halocarbyl, substituted halocarbyl, and halosubstituted-hydrocarbyl radicals, said Q having up to 20 carbon atoms with the proviso that in not more than 1 occurrence is Q a halide. Specifically, each Q is a fluorinated hydrocarbyl group having 1 to 20 carbon atoms, more specifically each Q is a fluorinated aryl group, and most specifically each Q is a pentafluoryl aryl group. Examples of suitable A^{d-} also include diboron compounds as disclosed in U.S. Pat. No. 5,447,895, which is fully incorporated herein by reference.

Illustrative, but not limiting examples of boron compounds which may be used as an activating cocatalyst in the preparation of the improved catalysts of this invention are tri-substituted ammonium salts such as:

trimethylammonium tetraphenylborate, triethylammonium tetraphenylborate, tripropylammonium tetraphenylborate, tri(n-butyl)ammonium tetraphenylborate, tri(t-butyl)ammonium tetraphenylborate, N,N-dimethylanilinium tetraphenylborate, N,N-diethylanilinium tetraphenylborate, N,N-dimethyl-(2,4,6-trimethylanilinium)tetraphenylborate, tropillium tetraphenylborate, triphenylcarbenium tetraphenylborate, triphenylphosphonium tetraphenylborate, triethylsilylium tetraphenylborate, benzene(diazonium)tetraphenylborate, trimethylammonium tetrakis(pentafluorophenyl)borate, triethylammonium tetrakis(pentafluorophenyl)borate, tripropylammonium tetrakis(pentafluorophenyl)borate, tri(n-butyl)ammonium tetrakis(pentafluorophenyl)borate, tri(sec-butyl)ammonium tetrakis(pentafluorophenyl)borate, N,N-dimethylanilinium tetrakis(pentafluorophenyl)borate, N,N-diethylanilinium tetrakis(pentafluorophenyl)borate, N,N-dimethyl-(2,4,6-trimethylanilinium)tetrakis(pentafluorophenyl)borate, tropillium tetrakis(pentafluorophenyl)borate, triphenylcarbenium tetrakis(pentafluorophenyl)borate, triphenylphosphonium tetrakis(pentafluorophenyl)borate, triethylsilylium tetrakis(pentafluorophenyl)borate, benzene(diazonium)tetrakis(pentafluorophenyl)borate, trimethylammonium tetrakis-(2,3,4,6-tetrafluorophenyl)borate, triethylammonium tetrakis-(2,3,4,6-tetrafluorophenyl)borate, tripropylammonium tetrakis-(2,3,4,6-tetrafluorophenyl)borate, tri(n-butyl)ammonium tetrakis-(2,3,4,6-tetrafluoro-phenyl)borate, dimethyl(t-butyl)ammonium tetrakis-(2,3,4,6-tetrafluorophenyl)borate, N,N-dimethylanilinium tetrakis-(2,3,4,6-tetrafluorophenyl)borate, N,N-diethylanilinium tetrakis-(2,3,4,6-tetrafluorophenyl)borate, N,N-dimethyl-(2,4,6-trimethylanilinium)tetrakis-(2,3,4,6-tetrafluorophenyl)borate, tropillium tetrakis-(2,3,4,6-tetrafluorophenyl)borate, triphenylcarbenium tetrakis-(2,3,4,6-tetrafluorophenyl)borate, triphenylphosphonium tetrakis-(2,3,4,6-tetrafluorophenyl)borate, triethylsilylium tetrakis-(2,3,4,6-tetrafluorophenyl)borate, benzene(diazonium)tetrakis-(2,3,4,6-tetrafluorophenyl)borate, trimethylammonium tetrakis(perfluoronaphthyl)borate, triethylammonium tetrakis(perfluoronaphthyl)borate, tripropylammonium tetrakis(perfluoronaphthyl)borate, tri(n-butyl)ammonium tetrakis(perfluoronaphthyl)borate, tri(t-butyl)ammonium tetrakis(perfluoronaphthyl)borate, N,N-dimethylanilinium tetrakis(perfluoronaphthyl)borate, N,N-diethylanilinium tetrakis(perfluoronaphthyl)borate, N,N-dimethyl-(2,4,6-trimethylanilinium)tetrakis(perfluoronaphthyl)borate, tropillium tetrakis(perfluoronaphthyl)borate, triphenylcarbenium tetrakis(perfluoronaphthyl)borate, triphenylphosphonium tetrakis(perfluoronaphthyl)borate, triethylsilylium tetrakis(perfluoronaphthyl)borate, benzene(diazonium)tetrakis(perfluoronaphthyl)borate, trimethylammonium tetrakis(perfluorobiphenyl)borate, triethylammonium tetrakis(perfluorobiphenyl)borate, tripropylammonium tetrakis(perfluorobiphenyl)borate, tri(n-butyl)ammonium tetrakis(perfluorobiphenyl)borate, tri(t-butyl)ammonium tetrakis(perfluorobiphenyl)borate, N,N-dimethylanilinium tetrakis(perfluorobiphenyl)borate, N,N-diethylanilinium tetrakis(perfluorobiphenyl)borate, N,N-dimethyl-(2,4,6-trimethylanilinium)tetrakis(perfluorobiphenyl)borate, tropillium tetrakis(perfluorobiphenyl)borate, triphenylcarbenium tetrakis(perfluorobiphenyl)borate, triphenylphosphonium tetrakis(perfluorobiphenyl)borate, triethylsilylium tetrakis(perfluorobiphenyl)borate, benzene(diazonium)tetrakis(perfluorobiphenyl)borate, trimethylammonium tetrakis(3,5-bis(trifluoromethyl)phenyl)borate, triethylammonium tetrakis(3,5-bis(trifluoromethyl)phenyl)borate, tripropylammonium tetrakis(3,5-bis(trifluoromethyl)phenyl)borate, tri(n-butyl)ammonium tetrakis(3,5-bis(trifluoromethyl)phenyl)borate, tri(t-butyl)ammonium tetrakis(3,5-bis(trifluoromethyl)phenyl)borate, N,N-dimethylanilinium tetrakis(3,5-bis(trifluoromethyl)phenyl)borate, N,N-diethylanilinium tetrakis(3,5-bis(trifluoromethyl)phenyl)borate, N,N-dimethyl-(2,4,6-trimethylanilinium)tetrakis(3,5-bis(trifluoromethyl)phenyl)borate, tropillium tetrakis(3,5-bis(trifluoromethyl)phenyl)borate, triphenylcarbenium tetrakis(3,5-bis(trifluoromethyl)phenyl)borate, triphenylphosphonium tetrakis(3,5-bis(trifluoromethyl)phenyl)borate, triethylsilylium tetrakis(3,5-bis(trifluoromethyl)phenyl)borate, benzene(diazonium)tetrakis(3,5-bis(trifluoromethyl)phenyl)borate, and dialkyl ammonium salts such as: di-(1-propyl)ammonium tetrakis(pentafluorophenyl)borate, and dicyclohexylammonium tetrakis(pentafluorophenyl)borate; and additional tri-substituted phosphonium salts such as tri(o-tolyl)phosphonium tetrakis(pentafluorophenyl)borate, and tri(2,6-dimethylphenyl)phosphonium tetrakis(pentafluorophenyl)borate.

Most specifically, the ionic stoichiometric activator (L-H)_{d}⁺(A^{d-}) is N,N-dimethylanilinium tetra(perfluorophenyl)borate, N,N-dimethylanilinium tetrakis(perfluoronaphthyl)borate, N,N-dimethylanilinium tetrakis(perfluorobiphenyl)borate, N,N-dimethylanilinium tetrakis(3,5-bis(trifluoromethyl)phenyl)borate, triphenylcarbenium tetrakis(perfluoronaphthyl)borate, triphenylcarbenium tetrakis(perfluorobiphenyl)borate, triphenylcarbenium tetrakis(3,5-bis(trifluoromethyl)phenyl)borate, or triphenylcarbenium tetra(perfluorophenyl)borate.

Other examples of preferred ionizing activators include, HNMe(C₁₈H₃₇)₂⁺B(C₆F₅)₄⁻; HNPh(C₁₈H₃₇)₂⁺B(C₆F₅)₄⁻ and ((4-n-Bu-C₆H₄)NH(n-hexyl)₂)⁺B(C₆F₅)₄⁻ and ((4-n-Bu-C₆H₄)NH(n-decyl)₂)⁺B(C₆F₅)₄⁻. Specific preferred (L*-H)⁺ cations are N,N-dialkylanilinium cations, such as HNMe₂Ph⁺, substituted N,N-dialkylanilinium cations, such as (4-n-Bu-C₆H₄)NH(n-C₆H₁₃)₂⁺ and (4-n-Bu-C₆H₄)NH(n-C₁₀H₂₁)₂⁺ and HNMe(C₁₈H₃₇)₂⁺. Specific examples of anions are tetrakis(3,5-bis(trifluoromethyl)phenyl)borate and tetrakis(pentafluorophenyl)borate.

In one embodiment, activation methods using ionizing ionic compounds not containing an active proton but capable of producing an active oligomerization catalyst are also contemplated. Such methods are described in relation to metallocene catalyst compounds in EP0426637A1, EP0573403A1 and U.S. Pat. No. 5,387,568, which are all herein incorporated by reference.

The process can also employ cocatalyst compounds or activator compounds that are initially neutral Lewis acids but form a cationic metal complex and a noncoordinating anion, or a zwitterionic complex upon reaction with the compounds of this invention. For example, tris(pentafluorophenyl)boron or aluminum may act to abstract a hydrocarbyl or hydride ligand to yield a cationic metal complex and stabilizing noncoordinating anion.

In some embodiments, ionizing activators may be employed as described in Köhn et al. (J. Organomet. Chem., 683, pp 200-208, (2003)) to, for example, improve solubility.

In another embodiment, the aforementioned cocatalyst compounds can also react with the compounds to produce a neutral, uncharged catalyst capable of selective ethylene oligomerization. For example, Lewis acidic reagents such as, for example, alkyl or aryl aluminum or boron compounds, can abstract a Lewis basic ligand such as, for example, THF or Et₂O, from a compound yielding a coordinatively unsaturated catalyst capable of selective ethylene oligomerization.

When the cations of noncoordinating anion precursors are Brönsted acids such as protons or protonated Lewis bases (excluding water), or reducible Lewis acids such as ferrocenium or silver cations, or alkali or alkaline earth metal cations such as those of sodium, magnesium or lithium, the activator-to-catalyst-precursor molar ratio may be any ratio, however, useful ratios can be from 1000:1 to 1:1.

Combinations of two or more activators may also be used in the practice of this invention.

Another suitable ion forming, activating cocatalyst comprises a salt of a cationic oxidizing agent and a noncoordinating, compatible anion characterized by the general formula:

(OX^{e+})_{d}(A^{d-})ₑ

where OX^{e+} is a cationic oxidizing agent having a charge of e+; e is an integer from 1 to 3; d is an integer from 1 to 3, and A^{d-} is as previously defined. Examples of cationic oxidizing agents include: ferrocenium, hydrocarbyl-substituted ferrocenium, Ag⁺, or Pb⁺². Preferred embodiments of A^{d-} are those anions previously defined with respect to the Brönsted acid containing activators, especially tetrakis(pentafluorophenyl)borate.

### Group 13 Reagents, Divalent Metal Reagents, and Alkali Metal Reagents

Other general activators or compounds useful in an oligomerization reaction may be used. These compounds may be activators in some contexts, but may also serve other functions in the reaction system, such as alkylating a metal center or scavenging impurities. These compounds are within the general definition of “activator,” but are not considered herein to be ion-forming activators. These compounds include a group 13 reagent that may be characterized by the formula G¹³R⁵⁰₃₋ₚDₚ where G¹³ is selected from the group consisting of B, Al, Ga, In, and combinations thereof, p is 0, 1 or 2, each R⁵⁰ is independently selected from the group consisting of hydrogen, halogen, and optionally substituted alkyl, alkenyl, alkynyl, heteroalkyl, heteroalkenyl, heteroalkynyl, aryl, heteroaryl, and combinations thereof, and each D is independently selected from the group consisting of halogen, hydrogen, alkoxy, aryloxy, amino, mercapto, alkylthio, arylthio, phosphino and combinations thereof.

In other embodiments, the group 13 activator is an oligomeric or polymeric alumoxane compound, such as methylalumoxane and the known modifications thereof. See, for example, Barron, “Alkylalumoxanes, Synthesis, Structure and Reactivity”, pp. 33-67 in Metallocene-Based Polyolefins: Preparation, Properties and Technology, J. Schiers and W. Kaminsky (eds.), Wiley Series in Polymer Science, John Wiley & Sons Ltd., Chichester, England, 2000, and references cited therein.

In other embodiments, a divalent metal reagent may be used that is characterized by the general formula M′R⁵⁰_{2-p′}D_{p′} and p′ is 0 or 1 in this embodiment and R⁵⁰ and D are as defined above. M′ is the metal and is selected from the group consisting of Mg, Ca, Sr, Ba, Zn, Cd, Cu and combinations thereof.

In still other embodiments, an alkali metal reagent may be used that is defined by the general formula M^{iv}R⁵⁰ and in this embodiment R⁵⁰ is as defined above, and M^{iv} is the alkali metal and is selected from the group consisting of Li, Na, K, Rb, Cs and combinations thereof. Additionally, hydrogen and/or silanes may be used in the catalytic composition or added to the polymerization system. Silanes may be characterized by the formula SiR⁵⁰_{4-q}D_{q} where R⁵⁰ is defined as above, q is 1, 2, 3 or 4 and D is as defined above, with the proviso that at least one D is hydrogen.

Non-limiting examples of Group 13 reagents, divalent metal reagents, and alkali metal reagents useful as activators for the catalyst compounds described above include methyl lithium, butyl lithium, phenyl lithium, dihexylmercury, butylmagnesium, diethylcadmium, benzylpotassium, diethyl zinc, tri-n-butyl aluminum, diisobutyl ethylboron, diethylcadmium, di-n-butyl zinc and tri-n-amyl boron, and, in particular, the aluminum alkyls, such as trihexyl-aluminum, triethylaluminum, trimethylaluminum, and triisobutyl aluminum, diisobutyl aluminum bromide, diethylaluminum chloride, ethylaluminum dichloride, isobutyl boron dichloride, methyl magnesium chloride, ethyl beryllium chloride, ethyl calcium bromide, diisobutyl aluminum hydride, methyl cadmium hydride, diethyl boron hydride, hexylberyllium hydride, dipropylboron hydride, octylmagnesium hydride, butyl zinc hydride, dichloroboron hydride, di-bromo-aluminum hydride and bromocadmium hydride. Other Group 13 reagents, divalent metal reagents, and alkali metal reagents useful as activators for the catalyst compounds described above are known to those in the art, and a more complete discussion of these compounds may be found in U.S. Pat. Nos. 3,221,002 and 5,093,415, which are herein fully incorporated by reference.

Other activators include those described in PCT publication WO98/07515 such as tris(2,2′,2″-nonafluorobiphenyl)fluoroaluminate, which publication is fully incorporated herein by reference. Combinations of activators are also contemplated by the invention, for example, alumoxanes and ionizing activators in combinations, see for example, EP0573120B1, PCT publications WO94/07928 and WO95/14044 and U.S. Pat. Nos. 5,153,157 and 5,453,410, all of which are herein fully incorporated by reference.

Other suitable activators are disclosed in WO98/09996, incorporated herein by reference, which describes activating bulky ligand metallocene catalyst compounds with perchlorates, periodates and iodates including their hydrates. WO98/30602 and WO98/30603, incorporated by reference, describe the use of lithium (2,2′-bisphenyl-ditrimethylsilicate).4THF as an activator for a bulky ligand metallocene catalyst compound. WO99/18135, incorporated herein by reference, describes the use of organo-boron-aluminum activators. EP0781299B1 describes using a silylium salt in combination with a non-coordinating compatible anion. Also, methods of activation such as using radiation (see EP0615981 B1 herein incorporated by reference), electro-chemical oxidation, and the like are also contemplated as activating methods for the purposes of rendering the chromium complexes or compositions active for the selective oligomerization of olefins. Other activators or methods are described in for example, U.S. Pat. Nos. 5,849,852, 5,859,653 and 5,869,723 and WO98/32775, WO99/42467 (dioctadecylmethylammonium-bis(tris(pentafluorophenyl)borane) benzimidazolide), which are herein incorporated by reference.

Additional optional activators include metal salts of noncoordinating or weakly coordinating anions, for example where the metal is selected from Li, Na, K, Ag, Ti, Zn, Mg, Cs, and Ba.

It is within the scope of this invention that metal-ligand complexes and or ligand-metal-precursor-combinations can be combined with one or more activators or activation methods described above. For example, a combination of activators has been described in U.S. Pat. Nos. 5,153,157 and 5,453,410, EP0573120B1, and PCT publications WO94/07928 and WO95/14044. These documents all discuss the use of an alumoxane in combination with an ionizing activator.

In one embodiment, the molar ratio of metal (from the metal-ligand-complex or the ligand-metal-precursor-combination) to activator (specifically Cr: activator, specifically Cr:Al or Cr:B) can range from 1:1 to 1:5000. In another embodiment, the molar ratio of metal to activator employed can range from 1:1 to 1:500. In another embodiment, the molar ratio of metal to activator employed can range from 1:1 to 1:50. In another embodiment, the molar ratio of chromium to activator employed can range from 1:1 to 1:500. In another embodiment, the molar ratio of chromium to activator employed can range from 1:1 to 1:50.

In embodiments where more than one activator is used, the order in which the activators are combined with the metal-ligand-complex or the ligand-metal-precursor-combination may be varied.

In some embodiments, the process of the invention relates to the oligomerization, and more specifically the dimerization of ethylene. The ligand-metal-precursor-combinations, metal-ligand-complexes, and/or catalyst systems of this invention are particularly effective at oligomerizing and specifically dimerizing ethylene to form 1-butene or 2-butene (cis or trans isomers).

In other embodiments, this invention relates to the oligomerization of α-olefins or co-oligomerization of ethylene with α-olefins. The trimerization of α-olefins is described in Köhn et al., Angew. Chem. Int. Ed., 39 (23), pp 4337-4339 (2000).

Very generally, oligomerization can be carried out in the Ziegler-Natta or Kaminsky-Sinn methodology, including temperatures from −100° C. to 300° C. and pressures from atmospheric to 3000 atmospheres (303,900 kPa). Suspension, solution, slurry, gas phase, or high-pressure oligomerization processes may be employed with the catalysts and compounds of this invention. Such processes can be run in a batch, semi-batch, or continuous mode. Examples of such processes are well known in the art.

Suitable solvents for oligomerization are non-coordinating, inert liquids. Examples include straight and branched-chain hydrocarbons such as isobutane, butane, pentane, isopentane, hexane, isohexane, heptane, octane, dodecane, and mixtures thereof; cyclic and alicyclic hydrocarbons such as cyclohexane, cycloheptane, methylcyclohexane, methylcycloheptane, and mixtures thereof; perhalogenated hydrocarbons such as perfluorinated C₄₋₁₀ alkanes, chlorobenzene, and aromatic and alkylsubstituted aromatic compounds such as benzene, toluene, mesitylene, and xylene. Suitable solvents also include liquid olefins, which may act as monomers or comonomers including ethylene, propylene, 1-butene, 1-hexene, 1-pentene, 3-methyl-1-pentene, 4-methyl-1-pentene, 1-octene, and 1-decene. Additional suitable solvents include ionic liquids and supercritical fluids. Mixtures of the foregoing are also suitable.

Other additives that are useful in an oligomerization reaction may be employed, such as scavengers, promoters, modifiers, reducing agents, oxidizing agents, dihydrogen, aluminum alkyls, or silanes. For example, Jolly et al. (Organometallics, 16, pp 1511-1513 (1997)) has reported the use of magnesium as a reducing agent for Cr compounds that were synthesized as models for intermediates in selective ethylene oligomerization reactions.

In some useful embodiments, the activator (such as methylalumoxane or modified methylalumoxane-3A) is combined with the metal-ligand-complex or the ligand-metal-precursor-combination immediately prior to introduction into the reactor. Such mixing may be achieved by mixing in a separate tank then swift injection into the reactor, mixing in-line just prior to injection into the reactor, or the like. It has been observed that in some instances, a short activation time is very useful. Likewise in-situ activation, where the catalyst system components are injected separately into the reactor, with or without monomer, and allowed to combine within the reactor directly is also useful in the practice of this invention. In some embodiments, the catalyst system components are allowed to contact each other for 30 minutes or less, prior to contact with monomer, alternately for 5 minutes or less, alternately for 3 minutes or less, alternately for 1 minute or less.

In another embodiment, the present invention relates to methods of producing oligomers of olefins, catalysts, ligands used to prepare the catalyst and catalyst compositions as described in the following paragraphs.

In another embodiment, this invention relates to:

1. A method of producing oligomers of olefins, comprising reacting an olefin with a catalyst under oligomerization conditions, wherein said oligomerization reaction has a selectivity of at least 70 mole percent for oligomer, and wherein said catalyst is formed from the combination of:

(1) a ligand characterized by the following general formula:

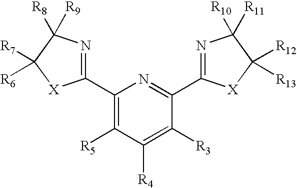

wherein R₃, R₄ and R₅ are independently selected from the group consisting of hydrogen, halogen, nitro, and optionally substituted alkyl, heteroalkyl, aryl, heteroaryl, alkoxy, aryloxy, silyl, boryl, phosphino, amino, alkylthio, arylthio, and combinations thereof, and optionally two or more R³, R⁴ and R⁵ groups may be joined to form one or more optionally substituted ring systems;

R₆, R₇, R₈, R₉, R₁₀, R₁₁, R₁₂ and R₁₃ are each individually selected from the group consisting of optionally substituted hydrocarbyl, heteroatom containing hydrocarbyl and hydrogen, optionally two or more R₆, R₇, R₈ and R₉ groups may be joined to form one or more optionally substituted ring systems and optionally two or more R₁₀, R₁₁, R₁₂ and R₁₃ groups may be joined to form one or more optionally substituted ring systems;

X is O or S;

(2) a metal precursor compound characterized by the general formula Cr(L)ₙ where each L is independently selected from the group consisting of halide, alkyl, substituted alkyl, cycloalkyl, substituted cycloalkyl, heteroalkyl, substituted heteroalkyl heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, ether, thioether, carboxylates, thio, 1,3-dionates, oxalates, carbonates, nitrates, sulfates, ethers, thioethers and combinations thereof, wherein two or more L groups may be combined in a ring structure having from 3 to 50 non-hydrogen atoms; n is 1, 2, 3, 4, 5, or 6; and

(3) optionally, one or more activators.

2. The method of paragraph 1, wherein R₆, R₇, R₈, R₉, R₁₀, R₁₁, R₁₂ and R₁₃ are each independently selected from the group consisting of optionally substituted alkyl, aryl, heteroaryl and hydrogen.
3. The method of paragraph 1, wherein one of R₈ or R₉ and one of R₁₀ or R₁₁ are each independently an optionally substituted aryl or heteroaryl.
4. The method of paragraph 1, wherein one of R₈ or R₉ and one of R₁₀ or R₁₁ are each independently an optionally substituted aryl and R₆, R₇, R₁₂ and R₁₃ are each hydrogen.
5. The method of paragraph 1, wherein one of R₈ or R₉ and one of R₁₀ or R₁₁ are each independently a phenyl and R₆, R₇, R₁₂ and R₁₃ are each hydrogen.
6. The method of paragraph 1, wherein the ligand is selected from the group consisting of ligands A1 through A18.
7. The method of any one of paragraphs 1 through 6, wherein the activator is an alumoxane, which may optionally be used in any combination with group 13 reagents, divalent metal reagents, or alkali metal reagents.
8. The method of any one of paragraphs 1 through 6, wherein the activator is a neutral or ionic stoichiometric activator, which may optionally be used in any combination with group 13 reagents, divalent metal reagents, or alkali metal reagents.
9. The method of any one of paragraphs 1 through 6, wherein the activator is selected from the group consisting of modified methylaluminoxane (MMAO), methylaluminoxane (MAO), trimethylaluminum (TMA), triisobutyl aluminum (TIBA), diisobutylaluminumhydride (DIBAL), polymethylaluminoxane-IP (PMAO-IP), triphenylcarbonium tetrakis(perfluorophenyl)borate, N,N-dimethyl-anilinium tetrakis(perfluorophenyl)borate N,N-di(n-decyl)-4-n-butyl-anilinium tetrakis(perfluorophenyl)borate, and mixtures thereof.
10. The method of any one of paragraphs 1 through 9, wherein the metal precursor is selected from the group consisting of (THF)₃CrMeCl₂, (Mes)₃Cr(THF) (Mes=mesityl=2,4,6-trimethylphenyl), [{TFA}₂Cr(OEt₂)]₂ (TFA=trifluoroacetate), (THF)₃CrPh₃, CrCl₃(THF)₃, CrCl₄(NH₃)₂, Cr(NMe₃)₂Cl₃, CrCl₃, Cr(acac)₃ (acac=acetylacetonato), Cr(2-ethylhexanoate)₃, Cr(neopentyl)₄, Cr(CH₂—C₆H₄-o-NMe₂)₃, Cr(TFA)₃, Cr(CH(SiMe₃)₂)₃, Cr(Mes)₂(THF)₃, Cr(Mes)₂(THF), Cr(Mes)Cl(THF)₂, Cr(Mes)Cl(THF)_{0.5}, Cr(p-tolyl)Cl₂(THF)₃, Cr(diisopropylamide)₃, Cr(picolinate)₃, [Cr₂Me₈][Li(THF)]₄, CrCl₂(THF), Cr(NO₃)₃, [CrMe₆][Li(Et₂O)]₃, [CrPh₆][Li(THF)]₃, [CrPh₆][Li(n-Bu₂O)]₃, [Cr(C₄H₈)₃][Li(THF)]₃, CrCl₂, Cr(hexafluoroacetylacetonato)₃, (THF)₃Cr(η²-2,2′-Biphenyl)Br and mixtures thereof.
11. The method of any one of paragraphs 1 through 9, wherein the metal precursor is selected from the group consisting of (THF)₃CrMeCl₂, (THF)₃CrCl₃, (Mes)₃Cr(THF), (THF)₃CrPh₃, [{TFA}₂Cr(OEt₂)]₂, (Mes)₂Cr(THF)₃, (Mes)₂Cr(THF), (Mes)CrCl(THF)₂, (Mes)CrCl(THF)_{0.5}, CrCl₂, CrCl₂(THF), and (THF)₃Cr(η²-2,2′-Biphenyl)Br.
12. The method of paragraph 1, wherein the olefin is a C₂ to C₁₂ olefin.
13. The method of paragraph 1, wherein the olefin is a C₂ to C₈ olefin.
14. The method of paragraph 1, wherein the olefin is ethylene.
15. The method of paragraphs 12, 13 or 14, wherein the process produces a dimer.
16. The method of paragraph 1, wherein the process produces butene.
17. The method of paragraph 1, wherein the process produces 1-butene.
18. The method of paragraph 1, wherein the reaction occurs in a hydrocarbon solvent.
19. The method of paragraph 1, wherein the reaction occurs in an aliphatic hydrocarbon solvent.
20. A composition comprising:

(1) a ligand characterized by the following general formula:

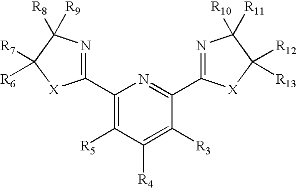

wherein R₃, R₄ and R₅ are independently selected from the group consisting of hydrogen, halogen, nitro, and optionally substituted alkyl, heteroalkyl, aryl, heteroaryl, alkoxy, aryloxy, silyl, boryl, phosphino, amino, alkylthio, arylthio, and combinations thereof, and optionally two or more R³, R⁴ and R⁵ groups may be joined to form one or more optionally substituted ring systems;

R₆, R₇, R₈, R₉, R₁₀, R₁₁, R₁₂ and R₁₃ are each individually selected from the group consisting of optionally substituted hydrocarbyl, heteroatom containing hydrocarbyl and hydrogen, optionally two or more R₆, R₇, R₈ and R₉ groups may be joined to form one or more optionally substituted ring systems and optionally two or more R₁₀, R₁₁, R₁₂ and R₁₃ groups may be joined to form one or more optionally substituted ring systems;

X is O or S;

provided when one of R₈ or R₉ and one of R₁₀ or R₁₁ is an i-propyl is not included;

(2) a metal precursor compound characterized by the general formula Cr(L)ₙ where each L is independently selected from the group consisting of halide, alkyl, substituted alkyl, cycloalkyl, substituted cycloalkyl, heteroalkyl, substituted heteroalkyl heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, ether, thioether, carboxylates, thio, 1,3-dionates, oxalates, carbonates, nitrates, sulfates, ethers, thioethers and combinations thereof, wherein two or more L groups may be combined in a ring structure having from 3 to 50 non-hydrogen atoms; n is 1, 2, 3, 4, 5, or 6; and

(3) optionally, one or more activators.

21. The composition of paragraph 20, wherein R₆, R₇, R₈, R₉, R₁₀, R₁₁, R₁₂ and R₁₃ are each independently selected from the group consisting of optionally substituted alkyl, aryl, heteroaryl and hydrogen.
22. The composition of paragraph 20, wherein one of R₈ or R₉ and one of R₁₀ or R₁₁ are each independently an optionally substituted aryl or heteroaryl.
23. The composition of paragraph 20, wherein one of R₈ or R₉ and one of R₁₀ or R₁₁ are each independently an optionally substituted aryl and R₆, R₇, R₁₂ and R₁₃ are each hydrogen.
24. The composition of paragraph 20, wherein one of R₈ or R₉ and one of R₁₀ or R₁₁ are each independently a phenyl and R₆, R₇, R₁₂ and R₁₃ are each hydrogen.
25. The composition of paragraph 20, wherein the ligand is selected from the group consisting of ligands A1 through A18 depicted in FIGS. 1 through 3.
26. The composition of any one of paragraphs 20 through 25, wherein the activator is an alumoxane, which may optionally be used in any combination with group 13 reagents, divalent metal reagents, or alkali metal reagents.
27. The composition of any one of paragraphs 20 through 25, wherein the activator is a neutral or ionic stoichiometric activator, which may optionally be used in any combination with group 13 reagents, divalent metal reagents, or alkali metal reagents.
28. The composition of any one of paragraphs 20 through 25, wherein the activator is selected from the group consisting of modified methylaluminoxane (MMAO), methylaluminoxane (MAO), trimethylaluminum (TMA), triisobutyl aluminum (TIBA), diisobutylaluminumhydride (DIBAL), polymethylaluminoxane-IP (PMAO-IP), triphenylcarbonium tetrakis(perfluorophenyl)borate, N,N-dimethyl-anilinium tetrakis(perfluorophenyl)borate N,N-di(n-decyl)-4-n-butyl-anilinium tetrakis(perfluorophenyl)borate, and mixtures thereof.
29. The composition of any one of paragraphs 20 through 28, wherein the metal precursor is selected from the group consisting of (THF)₃CrMeCl₂, (Mes)₃Cr(THF) (Mes=mesityl=2,4,6-trimethylphenyl), [{TFA}₂Cr(OEt₂)]₂ (TFA=trifluoroacetate), (THF)₃CrPh₃, CrCl₃(THF)₃, CrCl₄(NH₃)₂, Cr(NMe₃)₂Cl₃, CrCl₃, Cr(acac)₃ (acac=acetylacetonato), Cr(2-ethylhexanoate)₃, Cr(neopentyl)₄, Cr(CH₂—C₆H₄-o-NMe₂)₃, Cr(TFA)₃, Cr(CH(SiMe₃)₂)₃, Cr(Mes)₂(THF)₃, Cr(Mes)₂(THF), Cr(Mes)Cl(THF)₂, Cr(Mes)Cl(THF)_{0.5}, Cr(p-tolyl)Cl₂(THF)₃, Cr(diisopropylamide)₃, Cr(picolinate)₃, [Cr₂Me₈][Li(THF)]₄, CrCl₂(THF), Cr(NO₃)₃, [CrMe₆][Li(Et₂O)]₃, [CrPh₆][Li(THF)]₃, [CrPh₆][Li(n-Bu₂O)]₃, [Cr(C₄H₈)₃][Li(THF)]₃, CrCl₂, Cr(hexafluoroacetylacetonato)₃, (THF)₃Cr(η²-2,2′-Biphenyl)Br and mixtures thereof.
30. The composition of any one of paragraphs 20 through 28, wherein the metal precursor is selected from the group consisting of (THF)₃CrMeCl₂, (THF)₃CrCl₃, (Mes)₃Cr(THF), (THF)₃CrPh₃, [{TFA}₂Cr(OEt₂)]₂, (Mes)₂Cr(THF)₃, (Mes)₂Cr(THF), (Mes)CrCl(THF)₂, (Mes)CrCl(THF)_{0.5}, CrCl₂, CrCl₂(THF), and (THF)₃Cr(η²-2,2′-Biphenyl)Br.
31. A composition comprising:

(1) a ligand characterized by the following general formula:

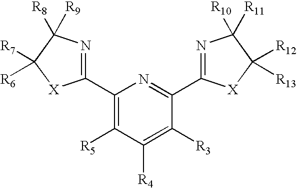

wherein R₃, R₄ and R₅ are independently selected from the group consisting of hydrogen, halogen, nitro, and optionally substituted alkyl, heteroalkyl, aryl, heteroaryl, alkoxy, aryloxy, silyl, boryl, phosphino, amino, alkylthio, arylthio, and combinations thereof, and optionally two or more R³, R⁴ and R⁵ groups may be joined to form one or more optionally substituted ring systems;

R₆, R₇, R₈, R₉, R₁₀, R₁₁, R₁₂ and R₁₃ are each individually selected from the group consisting of optionally substituted hydrocarbyl, heteroatom containing hydrocarbyl and hydrogen, optionally two or more R₆, R₇, R₈ and R₉ groups may be joined to form one or more optionally substituted ring systems and optionally two or more R₁₀, R₁₁, R₁₂ and R₁₃ groups may be joined to form one or more optionally substituted ring systems;

X is O or S;

provided when one of R₈ or R₉ and one of R₁₀ or R₁₁ is an i-propyl is not included;

(2) a metal precursor compound characterized by the general formula Cr(L)ₙ where each L is independently selected from the group consisting of halide, alkyl, substituted alkyl, cycloalkyl, substituted cycloalkyl, heteroalkyl, substituted heteroalkyl heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, ether, thioether, carboxylates, thio, 1,3-dionates, oxalates, carbonates, nitrates, sulfates, ethers, thioethers and combinations thereof, wherein two or more L groups may be combined in a ring structure having from 3 to 50 non-hydrogen atoms; n is 1, 2, 3, 4, 5, or 6; and

(3) one or more activators.

32. The composition of paragraph 31, wherein R₆, R₇, R₈, R₉, R₁₀, R₁₁, R₁₂ and R₁₃ are each independently selected from the group consisting of optionally substituted alkyl, aryl, heteroaryl and hydrogen.
33. The composition of paragraph 31, wherein one of R₈ or R₉ and one of R₁₀ or R₁₁ are each independently an optionally substituted aryl or heteroaryl.
34. The composition of paragraph 31, wherein one of R₈ or R₉ and one of R₁₀ or R₁₁ are each independently an optionally substituted aryl and R₆, R₇, R₁₂ and R₁₃ are each hydrogen.
35. The composition of paragraph 31, wherein one of R₈ or R₉ and one of R₁₀ or R₁₁ are each independently a phenyl and R₆, R₇, R₁₂ and R₁₃ are each hydrogen.
36. The composition of paragraph 31, wherein the ligand is selected from the group consisting of ligands A1 through A18 depicted in FIGS. 1 through 3.
37. The composition of any one of paragraphs 31 through 36, wherein the activator is an alumoxane, which may optionally be used in any combination with group 13 reagents, divalent metal reagents, or alkali metal reagents.
38. The composition of any one of paragraphs 31 through 36, wherein the activator is a neutral or ionic stoichiometric activator, which may optionally be used in any combination with group 13 reagents, divalent metal reagents, or alkali metal reagents.
39. The composition of any one of paragraphs 31 through 36, wherein the activator is selected from the group consisting of modified methylaluminoxane (MMAO), methylaluminoxane (MAO), trimethylaluminum (TMA), triisobutyl aluminum (TIBA), diisobutylaluminumhydride (DIBAL), polymethylaluminoxane-IP (PMAO-IP), triphenylcarbonium tetrakis(perfluorophenyl)borate, N,N-dimethyl-anilinium tetrakis(perfluorophenyl)borate N,N-di(n-decyl)-4-n-butyl-anilinium tetrakis(perfluorophenyl)borate, and mixtures thereof.
40. The composition of any one of paragraphs 31 through 39, wherein the metal precursor is selected from the group consisting of (THF)₃CrMeCl₂, (Mes)₃Cr(THF) (Mes=mesityl=2,4,6-trimethylphenyl), [{TFA}₂Cr(OEt₂)]₂ (TFA=trifluoroacetate), (THF)₃CrPh₃, CrCl₃(THF)₃, CrCl₄(NH₃)₂, Cr(NMe₃)₂Cl₃, CrCl₃, Cr(acac)₃ (acac=acetylacetonato), Cr(2-ethylhexanoate)₃, Cr(neopentyl)₄, Cr(CH₂—C₆H₄-o-NMe₂)₃, Cr(TFA)₃, Cr(CH(SiMe₃)₂)₃, Cr(Mes)₂(THF)₃, Cr(Mes)₂(THF), Cr(Mes)Cl(THF)₂, Cr(Mes)Cl(THF)_{0.5}, Cr(p-tolyl)Cl₂(THF)₃, Cr(diisopropylamide)₃, Cr(picolinate)₃, [Cr₂Me₈][Li(THF)]₄, CrCl₂(THF), Cr(NO₃)₃, [CrMe₆][Li(Et₂O)]₃, [CrPh₆][Li(THF)]₃, [CrPh₆][Li(n-Bu₂O)]₃, [Cr(C₄H₈)₃][Li(TH F)]₃, CrCl₂, Cr(hexafluoroacetylacetonato)₃, (THF)₃Cr(η²-2,2′-Biphenyl)Br and mixtures thereof.
41 The composition of any one of paragraphs 31 through 40, wherein the metal precursor is selected from the group consisting of (THF)₃CrMeCl₂, (THF)₃CrCl₃, (Mes)₃Cr(THF), (THF)₃CrPh₃, [{TFA}₂Cr(OEt₂)]₂, (Mes)₂Cr(THF)₃, (Mes)₂Cr(THF), (Mes)CrCl(THF)₂, (Mes)CrCl(THF)_{0.5}, CrCl₂, CrCl₂(THF), and (THF)₃Cr(η²-2,2′-Biphenyl)Br.

### EXAMPLES

General: All air sensitive procedures were performed under a purified argon or nitrogen atmosphere in a Vacuum Atmospheres or MBraun glove box. All solvents used were anhydrous, de-oxygenated and purified according to known techniques (see for example, D. D. Perrin & W. L. F. Armarego Purification of Laboratory Chemicals, 3^{rd} Ed., (Pergamon Press: New York, 1988)). All ligands and metal precursors were prepared according to procedures known to those of skill in the art, e.g., under inert atmosphere conditions, etc. Ethylene oligomerization experiments were carried out in a parallel pressure reactor, described in U.S. Pat. Nos. 6,306,658, 6,455,316 and 6,489,168, and in U.S. application Ser. No. 09/177,170, filed Oct. 22, 1998, WO 00/09255, and a parallel batch reactor with in situ injection capability, as described in WO 04/060550, and U.S. Application No. 2004/0121448, each of which is incorporated herein by reference.

Quantitative analysis of the liquid olefin products was performed using an automated Agilent 6890 Dual Channel Gas Chromatograph fitted with 2 Flame Ionization Detectors. The liquid olefin products were first separated using RT-x1 columns (1.25 m length×0.25 mm thickness×1 μm width; manufactured by Restek and spooled into module by RVM Scientific) and quantified by flame ionization detection by comparison with calibration standards. Samples were loaded onto the columns from an 8×12 array of 1 mL glass vials using a CTC HTS PAL LC-MS autosampler purchased from LEAPTEC. Polyethylene yields were determined using a Bohdan model BA-100 automated weighing module.

Chromatography was performed on a Biotage Flash+chromatography system (Biotage AB, Uppsala, Sweden).

### Example 1

### Ligand Synthesis

Several pyridine bis(oxazoline) ligands are commercially available. The following ligands are available from Aldrich Chemical Company, Milwaukee, Wis., USA: ((−)-2,6-bis[(4S)-4-phenyl-2-oxazolin-2-yl]pyridine, Ligand A1); R₉ and R₁₀=phenyl ((+)-2,6-bis[(4R)-4-phenyl-2-oxazolin-2-yl]pyridine, enantiomer of Ligand A1); R₈, R₁₁=methyl and R₆, R₁₂=phenyl; R₉, R₁₀=methyl and R₇, R₁₃=phenyl. The following ligands are available from Strem Chemicals, Inc., Newburyport, Mass., USA: R₈ and R₁₁=i-propyl; R₉ and R₁₀=i-propyl; R₈ and R₁₁=phenyl R₈ and R₁₁=t-butyl; R₉ and R₁₀=t-butyl. In all cases exemplified herein R₃, R₄ and R₅ on the pyridine ring (not shown below) are hydrogen.

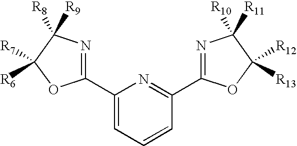

### Example 1a

### Synthesis of pyridyl bis(oxazoline) Ligand A2

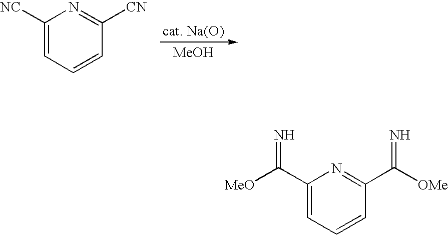

An excess of sodium metal (75-100 mg) was dissolved in anhydrous MeOH (13 mL). Once the sodium was completely reacted, the 2,6-dicyanopyridine (2.00 g) was added in one portion. The resulting solution was stirred for 42 h at ambient temp. The solution was then brought to pH=7 by addition of a 5% solution of acetic acid in MeOH. The volatile materials were removed on a rotary evaporator. The material was then taken up in hot ethyl acetate. The insoluble material was removed by filtration on a Büchner funnel. The solvent was removed yielding the pyridyl diimidate as a light yellow solid (2.90 g).

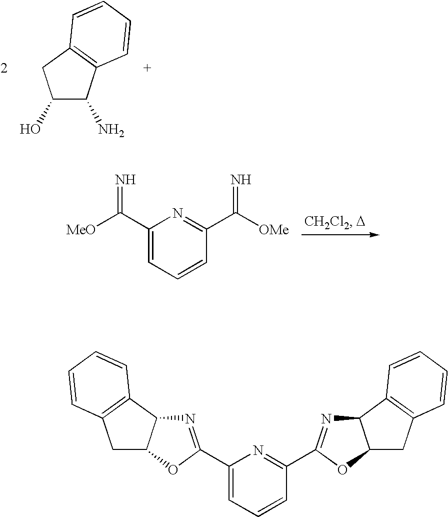

The pyridyl diimidate (0.250 g) and (1S,2R) 1-amino-2-indanol (0.424 g) were taken up in CH₂Cl₂ (8 mL). The resulting reaction mixture was heated under reflux overnight. After approximately 16 hours, the reaction mixture was cooled to ambient temperature. A minimum of CH₂Cl₂ was added to bring all of the material into solution. The solution was added directly to the top of a Biotage (40M, silica gel) cartridge. The column had been preconditioned with a hexane/ethyl acetate mixture (1:1). The material was eluted using EtOAc (200 mL) followed by 20% CH₂Cl₂ in EtOAc until the product was completely eluted. The product was obtained after evaporation of the eluent as a light yellow solid (0.329 g).

The pyridine bis(oxazoline) ligands described in the Table 1 below were synthesized according to the procedure described above.

TABLE 1

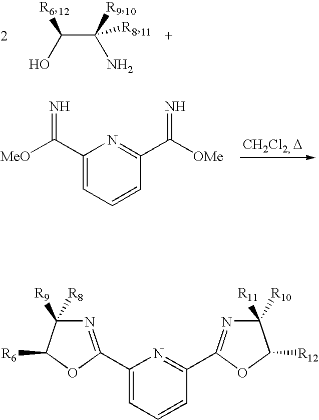

| | R₆, | R₈, | R₉, | |
|---|---|---|---|---|
| Ligand # | R₁₂ | R₁₁ | R₁₀ | Yield |
| A3 | H | Me | Me | 32% |
| A4 | H | Me | H | 21% |
| A5 | Ph | H | Ph | 29% |

R₇ and R₁₃ (not shown above) are hydrogen.

### Example 1b

### Synthesis of pyridyl bis(oxazoline) Ligand A6

The following example illustrates the use of a hydrochloride salt of the amino alcohol as the starting material.

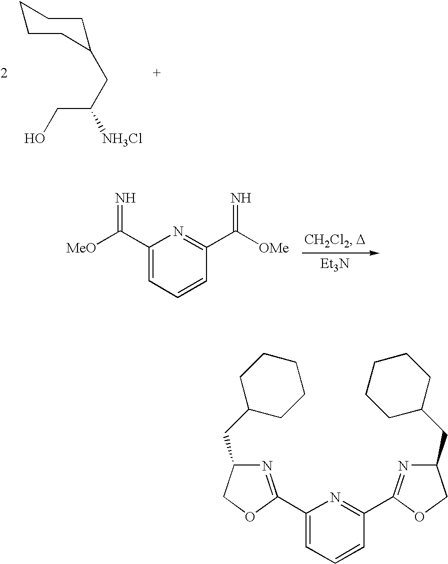

The pyridyl diimidate (0.200 g), Et₃N (0.32 mL) and (S)-2-amino-3-cyclohexyl-1-propanol hydrochloride (0.443 g) were taken up in CH₂Cl₂ (8 mL). The resulting reaction mixture was heated under reflux overnight. After approximately 16 hours, the reaction mixture was cooled to ambient temperature. The solution was added directly to the top of a Biotage (40M, silica gel) cartridge. The column had been preconditioned with a hexane/ethyl acetate mixture (1:1). The material was eluted using a stepped gradient of consisting of the following solvent concentrations: 50% EtOAc in hexane (300 mL) followed by 60% EtOAc in hexane (200 mL), and 70% EtOAc in hexane until the product was completely eluted from the column. The product was obtained after evaporation of the eluent as white solid (0.324 g).

### Example 1c

### Synthesis of pyridyl bis(thiazoline) Ligand A7

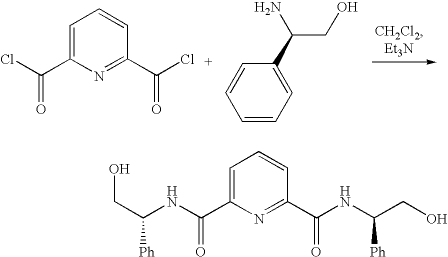

(R)-Phenylglycinol (0.400 g) and Et₃N (0.98 mL) were taken up in anhydrous CH₂Cl₂ (10 mL). The resulting solution was cooled in an ice/salt water bath. A solution of 2,6-pyridine dicarbonyldichloride (0.288 g) in anhydrous CH₂Cl₂ (5 mL) was added dropwise via syringe to the cooled aminoalcohol solution. The reaction vial was then allowed to come to ambient temperature slowly while stirring for 16 h. After approximately 16 hours, the reaction mixture was diluted to a total volume of 100 mL with CH₂Cl₂. The resulting solution was washed successively with saturated aqueous NaHCO₃ (30 mL), saturated aqueous NH₄Cl (30 mL) and brine (30 mL). The organic layer was dried over Na₂SO₄, filtered, and the solvent was removed on a rotary evaporator. The product was obtained in this manner as a white solid (0.552 g), which was used without further purification.

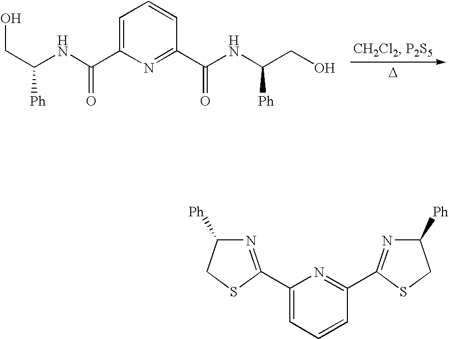

Phosphorus pentasulfide (0.276 g) and the diamide diol (0.300 g) were taken up in CH₂Cl₂ (8 mL). The reaction was heated under reflux for 40 h. The reaction mixture was then cooled to ambient temperature and then was diluted with CH₂Cl₂ (100 mL). The resulting solution was washed with aqueous 1 N NaOH (30 mL). The organic layer was separated and dried over Na₂SO₄. The mixture was then filtered and adsorbed onto silica gel for loading onto a Biotage cartridge (40S, silica gel). The material was eluted using the following solvent concentrations as a stepped gradient: hexane (200 mL), 5% EtOAc in hexane (200 mL), 10% EtOAc in hexane (200 mL), 15% EtOAc in hexane (200 mL) and 20% EtOAc in hexanes until the product was completely eluted from the column. The product was obtained after evaporation of the eluent as a light yellow solid (86 mg).

### Example 2

### Synthesis of Isolated Chromium-Ligand Complexes

Complex M1: Isolated Product from Reaction of Ligand A1 and Cr(mesityl)₂(THF)₃

A THF solution of Cr(mesityl)₂(THF)₃ (61.2 mg (0.121 mmol Cr) in 0.3 mL THF; mesityl=2,4,6-trimethyl-phenyl) was added to a toluene solution of Ligand A1 (45.5 mg, 0.123 mmol, 1.0 mL toluene) at room temperature. The solution immediately turned dark green. The reaction mixture was allowed to stand at room temperature for 1 hour and cooled to −35° C. for 16 hours. The reaction volume was reduced to 0.5 mL, and 20 mL pentane was added. A green powder formed, which was filtered and washed with 2×0.5 mL pentane. The solid was dried in vacuo for 2 hours and isolated as a green solid (isolated yield, 45 mg).

Complex M2: Isolated Product from Reaction of Ligand A1 and [{TFA}₂Cr(OEt₂)]₂

A toluene solution of [{TFA}₂Cr(OEt₂)]₂ (77.7 mg (0.220 mmol Cr) 5.0 mL toluene; TFA=trifluoroacetate=CO₂CF₃) was added to a toluene solution of Ligand A1 (83.1 mg, 0.225 mmol, 5.0 mL toluene) at room temperature. The solution immediately turned dark purple. The reaction mixture was allowed to stand at room temperature for 2 hours, and the solvent was then removed under a stream of N₂. The dark purple residue was dissolved in 1 mL CH₂Cl₂, layered with 3 mL pentane, then cooled to −35° C. for 16 hours whereupon a purple solid precipitated from the cold solution. The solid was isolated by removing the supernatant while cold, then washing with 3×4 mL pentane. The solid was dried in vacuo for 1.5 hours and isolated as a purple solid (isolated yield, 121 mg).

### Example 3

### Selective Ethylene Oligomerization Reactions in a 48-Well Parallel Pressure Reactor

For the purposes of calculating oligomerization reaction stoichiometries and concentrations, M1 and M2 described above were assumed to have a composition of the form of (A)Cr(L)₂ where A is the ligand of the invention and L is mesityl for M1 and L is TFA for M2. One of skill in the art will recognize that alternative complex compositions are possible for M1 and M2.

Ethylene oligomerization experiments were carried out in a parallel pressure reactor, described in U.S. Pat. Nos. 6,306,658, 6,455,316 and 6,489,168, and in U.S. application Ser. No. 09/177,170, filed Oct. 22, 1998, WO 00/09255. All air-sensitive procedures were performed under a purified argon or nitrogen atmosphere in a Vacuum Atmospheres or MBraun glove box. All glassware and the disposable stirring paddles were dried in a vacuum oven at 200° C. for at least 24 hours.

Quantitative analysis of the liquid olefin products was performed using an automated Agilent 6890 Dual Channel Gas Chromatograph fitted with 2 Flame Ionization Detectors. The liquid olefin products were first separated using RT-x1 columns (1.25 m length×0.25 mm thickness×1 μm width; manufactured by Restek and spooled into module by RVM Scientific) and quantified by flame ionization detection by comparison with calibration standards. Samples were loaded onto the columns from an 8×12 array of 1 mL glass vials using a CTC HTS PAL LC-MS autosampler purchased from LEAPTEC. Polyethylene yields were determined using a Bohdan model BA-100 automated weighing module.

3a. Stock Solution & Suspension Preparation

### Preparation of the Group 13 Reagent/Activator Stock Solution

A 200 mM solution of MMAO-3A in heptane was prepared by combining 2.20 mL of a 1.82 M solution of MMAO-3A in heptane (purchased from Akzo Chemical Inc., Chicago, Ill.) and 17.8 mL heptane.

### Preparation of Complex Solutions or Suspensions

For Example 3.1, 7.0 mg of Complex M1 [(A1)Cr(mesityl)₂] was dissolved in 2.12 mL of toluene, in a 4 mL glass vial, to give a 5 mM solution. For Example 3.2, 7.0 mg of Complex M2 [(A1)Cr(TFA)₂] and 2.16 mL of heptane were combined in a 4 mL glass vial. A slurry suspension (with a concentration equivalent to a molarity of 5 mM) was prepared by stirring the mixture vigorously for 6 hours at room temperature, the slurry was then stirred vigorously to create a uniform suspension from which the complex slurry was sampled for injection into the reactor.

3b. Reactor Preparation for Examples 3.1 and 3.2

A pre-weighed, pre-dried, glass vial insert was inserted into each reaction vessel of the reactor. 0.60 mL of a 200 mM solution of MMAO-3A (corresponding to 120 micromoles of MMAO-3A) in heptane was then added to the glass vial insert. A disposable stirring paddle was fitted to each reaction vessel of the reactor. The reactor was then closed, and 4.55 mL of heptane (to achieve a total liquid volume of 6.65 mL after the catalyst injection step), was injected into each pressure reaction vessel through a check valve. The temperature was then set to 80° C., and the stirring speed was set to 800 rpm, and the mixture was exposed to ethylene at 100 psi (0.69 MPa) pressure. Ethylene was supplied to maintain a pressure of 100 psi (0.69 MPa) in the pressure cell, and the temperature setting was maintained, using computer control, until the end of the selective oligomerization experiment.

3c. Injection of Catalyst Solution into the Pressure Reactor Vessel for Examples 3.1 and 3.2:

0.50 mL of heptane was robotically injected into the pressurized reaction vessel through a check valve. 40 seconds later, 0.040 mL of the complex solution or suspension described in section 3a above (corresponding to 0.2 micromoles of complex), was robotically aspirated from a 4 ml glass vial then injected into the pressurized reaction vessel through a check valve, followed immediately by injection of 0.960 mL of heptane.

3d. Oligomerization Reactions

After injection of the complex, the oligomerization reactions were allowed to continue for between 8.2 minutes and 30 minutes, during which time the temperature and pressure were maintained at their pre-set levels by computer control. The specific reaction times for each experiment are shown in Table 2. After the reaction time elapsed, the reaction was quenched by addition of an overpressure of oxygen (approximately 40 psi (0.28 MPa) of a 20% O₂/80% N₂ mixture) sent to the reactor. The reaction times were the lesser of the maximum desired reaction time or the time taken for a predetermined amount of ethylene gas to be consumed in the reaction.

3e. Product Analysis

After completion of the oligomerization reactions, the reactor was allowed to cool to 30° C. before it was vented. The glass vial inserts containing the reaction products were removed from the pressure cells and removed from the inert atmosphere dry box, then the glass vial inserts were transferred to a cold block (previously cooled to −20° C.) to reduce further loss of volatiles such as butene, and deionized water (100 μL) was added. While the solutions were still cold, 0.5 mL aliquots of the supernatant solutions were rapidly sampled to pre-cooled 1 ml vials in a cold aluminum microtiter plate (previously cooled to −20° C.), and the 1 mL vials were then sealed with a PTFE sheet and silicone rubber gasket. The plate of 1 mL vials was then centrifuged prior to analysis by the GC-FID technique described above. The remaining supernatant in the glass vial inserts was then decanted, and the vial inserts containing insoluble residues were then placed in a centrifuge evaporator and the volatile components were removed. After the volatile components had evaporated, the contents of the vials were dried thoroughly (to constant weight) at elevated temperature (approximately 80° C.) under reduced pressure in a vacuum oven. The vials were then weighed to determine the mass of solid product (final weight minus vial tare weight). The calculated mass of the catalyst and cocatalyst residue was then subtracted from the total mass to give the yield of polyethylene produced, as listed in Table 2.

Table 2 presents the results from the ethylene oligomerization reactions performed in a 48-well parallel pressure reactor. In Table 2, butene selectivity is shown as a percentage and is defined as 100×[micromoles of butene]/[sum of micromoles of C₄-C₁₆ olefins]. Catalyst activity (Turn Over Frequency, TOF) for production of butene is defined as the [micromoles of butene]/([micromoles of catalyst]*[reaction time in minutes]/60), as shown in the column “butene TOF”.

Due to the much higher volatility of butene compared to higher olefins (1-butene b.p.=−6.3° C., vs. 1-hexene=64° C.), loss of butene from solution on venting the reactor at 30° C., and subsequent solution handling, is expected to be disproportionately high. Consistent with this, the calculated micromoles of butene produced, when calculated from the uncorrected butene concentration from GC analysis, is significantly lower than expected from the measured ethylene consumption in the reactions. To correct for the loss of butene from solution, a correction factor was calculated by comparing the ethylene consumption in the examples with the ethylene consumption from 1-hexene selective ethylene oligomerization experiments performed under similar conditions. The corrected butene concentration was calculated as the product of the butene concentration measured by GC multiplied by the correction factor from the measured ethylene uptake (approximately 2.9).

The uncorrected and corrected micromoles of butene are shown below in Table 2, together with the catalyst activity (expressed as Butene Turn Over Frequency (TOF)), and butene selectivity, both calculated using the butene micromoles corrected for ethylene consumption as described above. The butene product of both examples is approximately 95% 1-butene, with approximately 5% combined total of trans-2-Butene and cis-2-Butene. Hexenes are the major liquid byproduct. The GC retention time for the major hexene isomer most closely matches 2-ethyl-1-butene, with 1-hexene the next most abundant, then 3-methyl-1-pentene.

TABLE 2

| | | | | | | | Micromoles | Butene TOF | Butene | |
|---|---|---|---|---|---|---|---|---|---|---|
| | | Complex | | | | | of -Butene | (mol per mol | Selectivity | |
| | | Solution | Micro- | Micro- | | Micromoles | from GC | per hr) | (%) | |
| | | Solvent | moles | moles | Reaction | of Butene | (corrected | (corrected | (corrected | Poly- |
| Example | Complex | (or Slurry | of | of | Time | from GC | for ethylene | for ethylene | for ethylene | ethylene |
| # | # | Diluent) | Complex | MMAO-3A | (mins) | (uncorrected) | consumption) | consumption) | consumption) | (mg) |
| 3.1 | M1 | Toluene | 0.2 | 120 | 8.2 | 2120 | 6060 | 222,000 | 96 | 2 |
| | | solution | | | | | | | | |
| 3.2 | M2 | Heptane | 0.2 | 120 | 30 | 1110 | 3200 | 32,000 | 97 | 17 |
| | | slurry | | | | | | | | |

The results of selective ethylene dimerization using ligands of the invention in combination with chromium precursors or with isolated chromium metal complexes are surprising. The results illustrate that certain combinations are more productive in the dimerization of ethylene, for example, to produce 1-butene at a higher selectivity and a lower selectivity toward polyethylene when compared with other chromium-ligand catalysts under similar conditions.

All documents described herein are incorporated by reference herein, including any priority documents and/or testing procedures to the extent they are not inconsistent with this text. As is apparent from the foregoing general description and the specific embodiments, while forms of the invention have been illustrated and described, various modifications can be made without departing from the spirit and scope of the invention. Accordingly, it is not intended that the invention be limited thereby. Likewise, the term “comprising” is considered synonymous with the term “including” for purposes of Australian law.

The invention claimed is:

1. A method of producing oligomers of olefins, comprising reacting an olefin with a catalyst under oligomerization conditions, wherein said oligomerization reaction has a selectivity of at least 70 mole percent for oligomer, and wherein said catalyst is formed from the combination of:
(1) a ligand characterized by the following general formula: 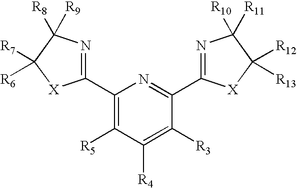
wherein R₃, R₄ and R₅ are independently selected from the group consisting of hydrogen, halogen, nitro, and optionally substituted alkyl, heteroalkyl, aryl, heteroaryl, alkoxy, aryloxy, silyl, boryl, phosphino, amino, alkylthio, arylthio, and combinations thereof, and optionally two or more R³, R⁴ and R⁵ groups may be joined to form one or more optionally substituted ring systems;
R₆, R₇, R₈, R₉, R₁₀, R₁₁, R₁₂ and R₁₃ are each individually selected from the group consisting of optionally substituted hydrocarbyl, heteroatom containing hydrocarbyl and hydrogen, optionally two or more R₆, R₇, R₈ and R₉ groups may be joined to form one or more optionally substituted ring systems and optionally two or more R₁₀, R₁₁, R₁₂ and R₁₃ groups may be joined to form one or more optionally substituted ring systems;
X is O or S;
(2) a metal precursor compound characterized by the general formula Cr(L)ₙ where each L is independently selected from the group consisting of halide, alkyl, substituted alkyl, cycloalkyl, substituted cycloalkyl, heteroalkyl, substituted heteroalkyl heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, ether, thioether, carboxylates, thio, 1,3-dionates, oxalates, carbonates, nitrates, sulfates, ethers, thioethers and combinations thereof, wherein two or more L groups may be combined in a ring structure having from 3 to 50 non-hydrogen atoms; n is 1, 2, 3, 4, 5, or 6; and
(3) optionally, one or more activators.

2. The method of claim 1, wherein R₆, R₇, R₈, R₉, R₁₀, R₁₁, R₁₂ and R₁₃ are each independently selected from the group consisting of optionally substituted alkyl, aryl, heteroaryl and hydrogen.

3. The method of claim 1, wherein one of R₈ or R₉ and one of R₁₀ or R₁₁ are each independently an optionally substituted aryl or heteroaryl.

4. The method of claim 1, wherein one of R₈ or R₉ and one of R₁₀ or R₁₁ are each independently an optionally substituted aryl and R₆, R₇, R₁₂ and R₁₃ are each hydrogen.

5. The method of claim 1, wherein one of R₈ or R₉ and one of R₁₀ or R₁₁ are each independently a phenyl and R₆, R₇, R₁₂ and R₁₃ are each hydrogen.

6. The method of claim 1, wherein the ligand is selected from the group consisting of ligands A1 through A18.

7. The method of claim 1, wherein the activator is an alumoxane, which may optionally be used in any combination with group 13 reagents, divalent metal reagents, or alkali metal reagents.

8. The method of claim 1, wherein the activator is a neutral or ionic stoichiometric activator, which may optionally be used in any combination with group 13 reagents, divalent metal reagents, or alkali metal reagents.

9. The method of claim 1, wherein the activator is selected from the group consisting of modified methylaluminoxane (MMAO), methylaluminoxane (MAO), trimethylaluminum (TMA), triisobutyl aluminum (TIBA), diisobutylaluminumhydride (DIBAL), polymethylaluminoxane-IP (PMAO-IP), triphenylcarbonium tetrakis(perfluorophenyl)borate, N,N-dimethyl-anilinium tetrakis(perfluorophenyl)borate N,N-di(n-decyl)-4-n-butyl-anilinium tetrakis(perfluorophenyl)borate, and mixtures thereof.

10. The method of claim 1, wherein the metal precursor is selected from the group consisting of (THF)₃CrMeCl₂, (Mes)₃Cr(THF) (Mes=mesityl=2,4,6-trimethylphenyl), [{TFA}₂Cr(OEt₂)]₂ (TFA=trifluoroacetate), (THF)₃CrPh₃, CrCl₃(THF)₃, CrCl₄(NH₃)₂, Cr(NMe₃)₂Cl₃, CrCl₃, Cr(acac)₃ (acac=acetylacetonato), Cr(2-ethylhexanoate)₃, Cr(neopentyl)₄, Cr(CH₂—C₆H₄-o-NMe₂)₃, Cr(TFA)₃, Cr(CH(SiMe₃)₂)₃, Cr(Mes)₂(THF)₃, Cr(Mes)₂(THF), Cr(Mes)Cl(THF)₂, Cr(Mes)Cl(THF)_{0.5}, Cr(p-tolyl)Cl₂(TH F)₃, Cr(diisopropylamide)₃, Cr(picolinate)₃, [Cr₂Me₈][Li(THF)]₄, CrCl₂(THF), Cr(NO₃)₃, [CrMe₆][Li(Et₂O)]₃, [CrPh₆][Li(THF)]₃, [CrPh₆][Li(n-Bu₂O)]₃, [Cr(C₄H₈)₃][Li(THF)]₃, CrCl₂, Cr(hexafluoroacetylacetonato)₃, (THF)₃Cr(η²-2,2′-Biphenyl)Br and mixtures thereof.

11. The method of claim 1, wherein the metal precursor is selected from the group consisting of (THF)₃CrMeCl₂, (THF)₃CrCl₃, (Mes)₃Cr(THF), (THF)₃CrPh₃, [{TFA}₂Cr(OEt₂)]₂, (Mes)₂Cr(THF)₃, (Mes)₂Cr(THF), (Mes)CrCl(THF)₂, (Mes)CrCl(THF)_{0.5}, CrCl₂, CrCl₂(THF), and (THF)₃Cr(2-2,2′-Biphenyl)Br.

12. The method of claim 1, wherein the olefin is a C₂ to C₁₂ olefin.

13. The method of claim 1, wherein the olefin is a C₂ to C₈ olefin.

14. The method of claim 1, wherein the olefin is ethylene.

15. The method of claim 1, wherein the process produces a dimer.

16. The method of claim 1, wherein the process produces butene.

17. The method of claim 1, wherein the process produces 1-butene.

18. The method of claim 1, wherein the reaction occurs in a hydrocarbon solvent.

19. The method of claim 1, wherein the reaction occurs in an aliphatic hydrocarbon solvent.

20. A composition comprising:
(1) a ligand characterized by the following general formula: 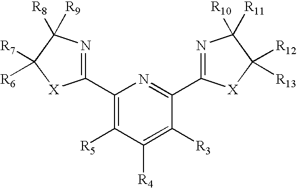
wherein R₃, R₄ and R₅ are independently selected from the group consisting of hydrogen, halogen, nitro, and optionally substituted alkyl, heteroalkyl, aryl, heteroaryl, alkoxy, aryloxy, silyl, boryl, phosphino, amino, alkylthio, arylthio, and combinations thereof, and optionally two or more R³, R⁴ and R⁵ groups may be joined to form one or more optionally substituted ring systems;
R₆, R₇, R₈, R₉, R₁₀, R₁₁, R₁₂ and R₁₃ are each individually selected from the group consisting of optionally substituted hydrocarbyl, heteroatom containing hydrocarbyl and hydrogen, optionally two or more R₆, R₇, R₈ and R₉ groups may be joined to form one or more optionally substituted ring systems and optionally two or more R₁₀, R₁₁, R₁₂ and R₁₃ groups may be joined to form one or more optionally substituted ring systems;
X is O or S;
provided when one of R₈ or R₉ and one of R₁₀ or R₁₁ is an i-propyl is not included;
(2) a metal precursor compound characterized by the general formula Cr(L)ₙ where each L is independently selected from the group consisting of halide, alkyl, substituted alkyl, cycloalkyl, substituted cycloalkyl, heteroalkyl, substituted heteroalkyl heterocycloalkyl, substituted heterocycloalkyl, aryl, substituted aryl, heteroaryl, substituted heteroaryl, alkoxy, aryloxy, hydroxy, boryl, silyl, amino, amine, hydrido, allyl, diene, seleno, phosphino, phosphine, ether, thioether, carboxylates, thio, 1,3-dionates, oxalates, carbonates, nitrates, sulfates, ethers, thioethers and combinations thereof, wherein two or more L groups may be combined in a ring structure having from 3 to 50 non-hydrogen atoms; n is 1, 2, 3, 4, 5, or 6; and
(3) optionally, one or more activators.

21. The composition of claim 20, wherein R₆, R₇, R₈, R₉, R₁₀, R₁₁, R₁₂ and R₁₃ are each independently selected from the group consisting of optionally substituted alkyl, aryl, heteroaryl and hydrogen.

22. The composition of claim 20, wherein one of R₈ or R₉ and one of R₁₀ or R₁₁ are each independently an optionally substituted aryl or heteroaryl.

23. The composition of claim 20, wherein one of R₈ or R₉ and one of R₁₀ or R₁₁ are each independently an optionally substituted aryl and R₆, R₇, R₁₂ and R₁₃ are each hydrogen.

24. The composition of claim 20, wherein one of R₈ or R₉ and one of R₁₀ or R₁₁ are each independently a phenyl and R₆, R₇, R₁₂ and R₁₃ are each hydrogen.

25. The composition of claim 20, wherein the ligand is selected from the group consisting of ligands A1 through A18.

26. The composition of claim 20, wherein the activator is an alumoxane, which may optionally be used in any combination with group 13 reagents, divalent metal reagents, or alkali metal reagents.

27. The composition of claim 20, wherein the activator is a neutral or ionic stoichiometric activator, which may optionally be used in any combination with group 13 reagents, divalent metal reagents, or alkali metal reagents.

28. The composition of claim 20, wherein the activator is selected from the group consisting of modified methylaluminoxane (MMAO), methylaluminoxane (MAO), trimethylaluminum (TMA), triisobutyl aluminum (TIBA), diisobutylaluminumhydride (DIBAL), polymethylaluminoxane-IP (PMAO-IP), triphenylcarbonium tetrakis(perfluorophenyl)borate, N,N-dimethyl-anilinium tetrakis(perfluorophenyl)borate N,N-di(n-decyl)-4-n-butyl-anilinium tetrakis(perfluorophenyl)borate, and mixtures thereof.

29. The composition of claim 20, wherein the metal precursor is selected from the group consisting of (THF)₃CrMeCl₂, (Mes)₃Cr(THF) (Mes=mesityl=2,4,6-trimethylphenyl), [{TFA}₂Cr(OEt₂)]₂ (TFA=trifluoroacetate), (THF)₃CrPh₃, CrCl₃(THF)₃, CrCl₄(NH₃)₂, Cr(NMe₃)₂Cl₃, CrCl₃, Cr(acac)₃ (acac=acetylacetonato), Cr(2-ethylhexanoate)₃, Cr(neopentyl)₄, Cr(CH₂—C₆H₄-o-NMe₂)₃, Cr(TFA)₃, Cr(CH(SiMe₃)₂)₃, Cr(Mes)₂(THF)₃, Cr(Mes)₂(THF), Cr(Mes)Cl(THF)₂, Cr(Mes)Cl(THF)_{0.5}, Cr(p-tolyl)Cl₂(THF)₃, Cr(diisopropylamide)₃, Cr(picolinate)₃, [Cr₂Me₈][Li(THF)]₄, CrCl₂(THF), Cr(NO₃)₃, [CrMe₆][Li(Et₂O)]₃, [CrPh₆][Li(THF)]₃, [CrPh₆][Li(n-Bu₂O)]₃, [Cr(C₄H₈)₃][Li(THF)]₃, CrCl₂, Cr(hexafluoroacetylacetonato)₃, (THF)₃Cr(2-2,2′-Biphenyl)Br and mixtures thereof.

30. The composition of claim 20, wherein the metal precursor is selected from the group consisting of (THF)₃CrMeCl₂, (THF)₃CrCl₃, (Mes)₃Cr(THF), (THF)₃CrPh₃, [{TFA}₂Cr(OEt₂)]₂, (Mes)₂Cr(THF)₃, (Mes)₂Cr(THF), (Mes)CrCl(THF)₂, (Mes)CrCl(THF)_{0.5}, CrCl₂, CrCl₂(THF), and (THF)₃Cr(η²-2,2′-Biphenyl)Br.
